(19) United States
(12) Patent Application Publication
(10) Pub. No.: US 2006/0143767 A1
(43) Pub. Date: Jul. 6, 2006

(54) Breathable protective articles

(76) Inventors: Kaiyuan Yang, Cumming, GA (US); Jeffrey E. Fish, Dacula, GA (US); Oomman Painummoottil Thomas, Alpharetta, GA (US); Martin S. Shamis, Alpharetta, GA (US)

Correspondence Address: KIMBERLY-CLARK WORLDWIDE, INC., 401 NORTH LAKE STREET, NEENAH, WI, 54956, US

(21) Appl. No.: 11/011,716

(22) Filed: Dec. 14, 2004

(51) Int. Cl. B32B 5/02; B32B 27/12; B32B 5/22

(52) U.S. Cl. 2/16; 442/394; 442/328; 442/76; 442/77; 442/392; 442/85; 442/381

(57) ABSTRACT

A protective article formed of a laminate between at least a layer of a liquid-impermeable, vapor-permeable barrier, and at least a layer of a stretchable or elastomeric, nonwoven fiber web is described. The barrier is reinforced at least on one side by the nonwoven fiber web, which remains elastic after being bonded to the barrier layer. The elasticity of both barrier and bonded fiber layers simulate the flexibility of natural or synthetic latex or other polymer films. The nonwoven fiber web includes at least about 75% of individual fibers with a length of over about 1 mm, and the fibers are substantially continuous. A second nonwoven web, a second barrier layer, or both may be attached to the exterior side of the breathable barrier. An elastomeric material coating, such as either a nature or synthetic latex or other polymers, may be applied over at least a portion of the article to provide for additional protection.

### FIELD OF INVENTION

The present invention relates generally to a breathable protective article made with a laminate construction of at least a vapor permeable barrier layer and a nonwoven web.

### BACKGROUND

Coverings, such as gloves, mitts, socks, shoes, or boots, long have been used to protect hands and feet from environmental or work conditions. Depending on the type of environment, nature of work, or desired properties, these type of coverings have been made from a variety of materials, which have included woven cloth fabrics, leather, natural latex or synthetic polymer elastomeric materials, or combinations of such materials. These articles typically have been designed for durable use.

The vast majority of gloves or foot covers, typically, have been made from either woven cloth fabrics, swade or leather. Gloves made of woven fabrics generally allow the skin of the wear to breathe through the spaces between the individual strands of woven fabric material, and any perspiration from the hand or foot is wicked away by the fabric. Leather tends not to fit as comfortably as cloth or fabric-lined articles, nor is it as flexible, or permits the skin to breathe as easily. Moreover, leather, while resilient, typically is not as good of a barrier against prolonged exposure to wetness or hazards as polymeric elastomer materials. For applications that require greater protection against fluids, chemicals, or microscopic pathogens, such as found in laboratory, healthcare and clinical, or other work settings, the protective articles—gloves in particular—traditionally have incorporated a barrier layer that is impervious to both undesirable substances. Surgical, examination or work gloves, for example, typically are made using natural or synthetic rubber latex or other elastic polymer membranes, which generally exhibit good barrier properties. Unfortunately, the good barrier properties of such materials, however, may create a harsh environment for the wearer's skin, which is bad for skin/hand health. For example, wearing a glove made from an elastic polymer latex for prolonged periods can trap perspiration in the article because the wearer's skin is not able to adequately breathe, making the glove uncomfortable to wear. As perspiration accumulates, the moist environment within the article may become a potential source or incubator for the growth of fungi or yeast, as well as bacterial or viral contamination, which can exacerbate skin problems.

People have tried to solve these problems in a variety of ways, for instance, by combining woven and elastomeric materials. A common practice has been to unite a woven or cloth-like material as an underlayer with an elastomeric membrane or film as a barrier overcoat, for a strong and resistant article (e.g., as described in U.S. Pat. Nos. 2,060,961, or 5,246,658, or U.S. Patent Publication No. 2004/0139529). Manufacturers have used knit, woven, or non-woven fabrics as liners in a variety of durable industrial gloves that can have a relatively long work life. Such gloves can be made in a variety of ways. For instance as described in the patent examples, glove are fabricated by providing a hand-shaped block mould or former, applying or fitting a woven or knit glove-shaped liner, then dipping into a polymer solution, such as latex or nitrile, to cover the glove liner. Typically, the liners for such gloves are generally thick, hence gloves made from this type of processes usually have poor flexibility and fit loosely to the hand. In some other cases, fabrics are first laminated to a polymer layer and then sealed under harsh conditions to form an air and water-proof seam, such as described in U.S. Pat. No. 5,981,019, which discloses an air and liquid-proof protective cover for use in harsh environments. Furthermore, the configuration of the human hand is such that the thumb projects considerably beyond the palm, and the thumb and other four fingers can move relatively freely in relation to each other to perform any desired task. Gloves that are made according to conventional methods are often made on a flat hand-shaped dipping mould or a last. Since a hand or foot has three-dimensionality, gloves or foot covers that are made in largely flat moulds does not fit the hand or foot well when worn and feels uncomfortable, which can be cumbersome when working.

According to other approaches, manufacturers fabricate elastomeric articles reinforced with fibers. Common work gloves, such as for housework or industrial uses, are examples of this latter design. Manufacturers of fiber-reinforced gloves incorporate an internal lining composed of fibrous material, such as cotton flock (e.g., U.S. Pat. Nos. 4,918,754, 4,536,890, or 5,581,812). Typically, flock is composed of finely divided, short, ground, fibrous particles, which can be applied as a lining by spraying the flock particles onto an adhesive-covered backing (e.g., the external shell of a glove). An inner glove lining of flock provides a smooth, comfortable feeling, cushions the hands, absorbs perspiration and keeps the hands dry, insulates against moderate heat and cold without being bulky, makes the glove easier to put on and take off, and has other advantageous characteristics. Gloves with such characteristics are favored by workers and have become common articles for various heavy-duty industrial applications.

The disadvantages, however, of a glove having an internal lining composed of cotton flock or other similar fibrous material are many. First, for instance, fibers and particles can become detached from the internal lining over time through abrasion with either the glove wearer's hand or the surface of the sleeve of a garment worn by the wearer. The detached particles can migrate out of the glove, particularly when the glove is being donned or removed from the wearer's hand. Second, fibers like short cotton fibers, typically are not elastomeric, which makes them difficult to coat onto glove skins made of latex or nitrile materials, etc. The current commercial flocking process uses glue to make the short cotton fibers stick, which is essentially a batch process and fibers can not be embedded into the polymer layers effectively.

Like in elastomeric articles, current-commercial flocked gloves, in some cases, use powder, such as cornstarch or calcium carbonate powders, to enhance the donning and comfort. The presence of powders may help absorb some of the perspiration moisture and alleviate some of the problems the wearer faces. The use of powder, however, was only partially successful, as the powder particles could absorb only a limited amount of the moisture. Additionally, powders are not well accepted among consumers because of allergy and health concerns of small particles, or for certain uses, such as in clear-room type applications and during surgical procedures, powders may be used at all.

Aside from industrial-type gloves with cotton liners or fabric liners, currently very few examples of disposable gloves exist that incorporate coated fibers, which can provide qualities such as comfort, good fit with flexibility, easy donning or insertion of the hand, being powder-free, allergy prevention, skin protection, and moisture absorption. For disposable latex gloves, the challenge is to create an elastomeric fiber-layer without limiting the fiber length and size to make economically viable flexible, fiber-lined, disposable gloves. Unfortunately, current technologies for durable industrial gloves cannot satisfy this challenge.

Attempts to remedy this situation have had limited success. For example, in U.S. patent application Ser. Nos. 10/732,959, and 10/732,965, disclose processes for coating directly elastomeric fibers on to a latex-coated glove former, on which fibers are coated to the latex as soon as fibers are spun out from a melt-blown die-tip. With this process, disposable latex gloves can be manufactured with an elastomeric fiber reinforcement coating. Although direct fiber coating to the glove former is a good process for making disposable latex gloves, the process has limitations. For example, the melt-blowing process as used for directly coating uses air to facilitate the fiber forming. This technique is not able to spray all of the fibers on to the former and leads to the loss of material. Also, the process is limited to polymers that can be coated on the glove former by a dipping process.

Conventional protective articles, as gloves and foot covers, are designed for durable or longtime use. The manufacturing process and materials, such as woven cloth or leather, used in making conventional gloves tend to be relatively more expensive and complicated, when compared to disposable or single use articles, which tend to be made from latex or other polymers, which are relatively inexpensive and easier to manufacture. Latex and polymer gloves, however, have the disadvantage of being not breathable and not durable. Given this situation, a need exists for a new type of protective glove or foot cover that is breathable, fits snugly without binding, and has the characteristics of more conventional durable lined gloves, but also can be made quickly and economically like single-use articles. The new articles can be made with a process that involves nonwoven fibers and other polymers for disposable fiber reinforced gloves and footwear.

### SUMMARY OF THE INVENTION

The present invention relates in part to protective articles or garments, such as gloves, foot wear, coverings, or drapes. In particular, the invention describes breathable protective articles that have a laminate construction incorporating at least a barrier layer and at least a nonwoven fiber web layer. The protective article may further includes a second barrier layer or a second nonwoven fiber layer, or both, such that the first barrier layer is either between the first nonwoven fiber layer and an adjacent second nonwoven fiber layer, or between the first non-woven fiber layer and an adjacent second barrier layer.

The barrier layer is liquid impermeable, but vapor permeable for a breathable article. The barrier layer is reinforced on at least one side with at least a non-woven fiber layer. The non-woven layer can be stretchable in at least one direction and preferably has multidirectional elasticity to enable the protective article to be able to flex while fitting snuggly against a portion of a wear's body. A snug fit refers to a state of being substantially conformable to the shape and size of a portion of the body that may be enveloped within the article. In the present invention, the article should not be excessively large and baggy, but rather should fit closely and conform comfortably to the wearer's body. To achieved a snug but flexible fit, according to the invention, the non-woven material has both cross-directional (CD) as well as machine-directional (MD) stretch elasticity. Cross-directional elasticity refers to an ability or characteristic of a laminate being pulled to stretch elastically in a direction orthogonal (i.e., transverse direction) to the general machine direction of a non-woven material. The non-woven fiber layer is necked (i.e., stretched and allowed to contract in width) prior to lamination with the barrier layer. Hence, the CD materials are also known as Necked Spunbonded Laminate (NBL). The fibers in the nonwoven web can be substantially continuous fibers of relatively long length, and can be elastomeric. The non-woven web can have at least about 75% or 80%, desirably at least about 85-90%, of individual fibers with a length of over about 1 mm. The non-woven fiber layer may include stretchable bonded, carded webs, point unbonded webs, and other suitable fabric configurations, for a better comfort and fit to hand or foot.

As constructed in a protective article, it is desirable that the nonwoven fiber layer should form the layer that directly contacts the user's skin. This inner nonwoven layer, in some embodiments, may be treated with therapeutic agents to impart health benefits either to the wearer's skin, joints, or other body parts. The breathable barrier layer functions as a liquid moisture barrier and provides a minimal level of protection from the outside environment. For greater protection, the article may further incorporate at least an impermeable elastomeric component as an over coating, which either partially or fully covers the body substrate of the article. The elastomeric component may form at least part of the barrier layer, or may be a separate, additional overcoat layer to the barrier layer. The elastomeric component may be composed of a material selected from a natural or synthetic polymer-based elastomer, such as natural latex rubber, nitrile, vinyl, or styrene-ethylene-butylene-styrene (S-EB-S), or styrene-butadiene-styrene (SBS) materials. One may apply the elastomeric component coating to the barrier and nonwoven laminated body substrate by means of either a dipping, silk-screening, or spraying process, when the substrate is arranged on an appropriately shaped mould or last. When part of the barrier layer, the polymer components will likely have been prefabricated as a constituent of the polymer barrier film.

Since a first nonwoven fiber web is a layer of the article that comes in direct contact with a user's skin or body, wicking of perspiration or other moisture away from the skin should be an objective. The nonwoven fabric layer can be configured to accomplish this by means of, for example, either adapting the nonwoven layer's physical structure for capillarity, or modifying the layer with specific treatments, such as with surfactants, to facilitate wicking. Once the moisture is drawn away from the user's skin, depending on the embodiment and desired use of the article, the moisture may be channeled to an area on the article for evaporation through the breathable barrier layer. In certain embodiments the entire surface of the article may be breathable, while in other embodiments, which may have an overcoat of an impermeable nature or synthetic polymer latex over, for example, either the area of the palm and fingers in a glove or the sole of the foot in a sock, evaporation would be channeled to areas such as either the back of the hand, the top of the foot, respectively, or the cuff of either.

In some embodiments, an additional nonwoven fabric layer and/or a second barrier layer can augment the minimal bilayer construction—the first breathable barrier layer and the first nonwoven fiber layer. This second nonwoven layer or the second barrier layer, absent the second nonwoven layer, may be directly attached over the first barrier layer, on its exterior side. The second nonwoven fabric layer may be adapted for texture, for example, either to improve gripping or non-skidding properties of the protective article, or to enable one to have a roughened surface for cleaning applications. Alternatively, the second nonwoven material can be treated with antimicrobial agents or other functional chemistries. Over the second nonwoven fabric layer one can further laminated another barrier layer or coated with an impermeable elastomeric component. The repeat of alternating barrier or nonwoven layers are envisioned in some embodiments. The second barrier layer may be similar to the first barrier layer, and may function as an additional protective film, or the second barrier layer can be adapted for a function different from the first barrier layer, as one may desire.

The gloves made according to the present invention can be used in areas or markets currently dominated by latex or other polymer gloves, such as in laboratories, clinical or hospital settings, industrial settings, food handling, home settings, and the like. The present gloves can achieve barrier and protection needs of users in chemical, biological or medical labs, or health care providers, etc., with acceptable and sometimes superior performance. In a sense, the current inventive gloves can fill the gap between disposable latex gloves and either flock or woven fiber lined industrial gloves.

Additionally, the present articles can be used to treat various appendage ailments. It is envisioned that according to certain embodiments, a glove or foot cover of the present invention can deliver an additive or active agent for therapeutic purposes to the wear's skin. In other embodiments, the outmost surface of the article can be modified and textured for greater grip and utility as a cleaning article.

Additional features and advantages of the present time protective articles and associated methods of manufacture will be disclosed in the following detailed description. It is understood that both the foregoing summary and the following detailed description and examples are merely representative of the invention, and are intended to provide an overview for understanding the invention as claimed.

### BRIEF DESCRIPTION OF THE DRAWINGS

A full and enabling disclosure of the present invention, including the best mode thereof, directed to one of ordinary skill in the art, is set forth in the specification, which makes reference to the appended drawings.

FIG. 1 shows a perspective view from the back of a glove according to an embodiment of the present invention.

FIG. 2 shows another perspective view of the same glove as in FIG. 1 from the palm side.

FIG. 3 is an exploded perspective view of a glove with a breathable barrier layer and a nonwoven fabric layer, according to the present invention.

FIG. 4 shows a perspective view of a glove according to an alternate embodiment of the present invention.

FIG. 5A illustrates a cross-sectional, cut-away view of a finger of a nonwoven glove according to the present invention. A seam 41 having a width joins two panels of nonwoven material along edge around the finger section. Extra bonding points are shown along the edge of the seam. The section creates a hollow pocket 42. FIG. 5B shows an illustration of the seam spread open and between the two flattened panels of the glove.

FIG. 6 is a photo of a stiff seam taken under microscopic magnification according to the present invention.

FIG. 7 is a photo of a flush seam taken under microscopic magnification according to another embodiment of the present invention;

FIG. 8 is another microscopic photo of a flush seam according to another embodiment of the present invention.

FIG. 9 is a perspective view of a glove, according to one embodiment of the present invention, having a number of extra bonding points at certain locations which can experience stresses that typically can cause seams to rupture and failure in conventional nonwoven gloves.

FIG. 10 is a perspective view of a glove having extra strengthening polymer dots on the palm area according to one embodiment of the present invention.

FIG. 11 is an alternative version of the embodiment shown in FIG. 10, but with open finger ends.

FIG. 12 is a perspective view of a glove, according to one embodiment of the present invention, having multiple sections. Each of the sections may be composed of the same or different nonwoven webs and/or barrier layers, depending on the desired properties or characteristics, and intended uses of each respective section of the glove. For instance, a the palm and finger may be relatively more resilient and textured, while the cuff area is more elastic, and the back of the glove is more breathable.

Repeat use of reference characters in the present specification and drawings is intended to represent the same or analogous features or elements of the invention.

### DETAILED DESCRIPTION OF REPRESENTATIVE EMBODIMENTS

### Section I—Definitions

Before describing the present invention in detail, the terminology used herein is for the purpose of describing particular embodiments only, and is not intended to be limiting. The invention should not necessarily be limited to specific compositions, materials, designs or equipment, as such may vary. All technical and scientific terms used herein have the usual meaning conventionally understood by persons skilled in the art to which this invention pertains, unless context defines otherwise. As used in this specification and the appended claims, the singular forms “a,” “an,” and “the” include plural referents unless the context clearly dictates otherwise.

The term “biconstituent fibers” (sometimes also referred to as “multiconstituent fibers”) as used herein refers to filaments or fibers that have been formed from at least two polymers, or the same polymer with different properties or additives, extruded from the same extruder as a blend. Biconstituent fibers do not have the various polymer components arranged in relatively constantly positioned distinct zones across the cross-sectional area of the fiber and the various polymers are usually not continuous along the entire length of the fiber, instead usually forming fibrils or protofibrils which start and end at random. Fibers of this general type are discussed in, for example, U.S. Pat. Nos. 5,108,827 and 5,294,482, to Gessner. Biconstituent fibers are also discussed in the textbook POLYMER BLENDS AND COMPOSITES by John A. Manson and Leslie H. Sperling, Plenum Press, a division of Plenum Publishing Corporation of New York, IBSN 0-306-30831-2, pp. 273-277, ©1976.

The term “breathable” as used herein refers to materials that are pervious to water vapor and gases. In other words, “breathable barriers” and “breathable films” allow water vapor to pass through, but still protect the users skin from microbes or other infectious agents. For example, “breathable” can refer to a film or laminate having a moisture vapor transmission rate (MVTR) of at least about 300 g/m² per 24 hours measured using ASTM Standard E96-80, upright cup method, with minor variations as described in the following: A measure of the breathability of a fabric is the moisture vapor transmission rate (MVTR) which, for sample materials, is calculated essentially in accordance with ASTM Standard E96-80 with minor variations in test procedure as set forth herein below. Circular samples measuring three inches in diameter are cut from each of the test materials, and tested along with a control, which is a piece of “CELGARD” 2500 sheet from Celanese Separation Products of Charlotte, N.C. “CELGARD” 2500 sheet is a microporous polypropylene sheet. Three samples are prepared for each material. The test dish is a No. 60-1 Vapometer pan distributed by Thwing-Albert Instrument Company of Philadelphia, Pa. 100 milliliters of water is poured into each Vapometer pan and individual samples of the test materials and control material are placed across the open tops of the individual pans. Screw-on flanges are tightened to form a seal along the edges of the pan, leaving the associated test material or control material exposed to the ambient atmosphere over a 6.5 cm diameter circle having an exposed area of approximately 33.17 cm². The pans are placed in a forced air oven at 100° F. (32° C.) for one hour to equilibrate. The oven is a constant temperature oven with external air circulating through it to prevent water vapor accumulation inside. A suitable forced air oven is, for example, a Blue M Power-O-Matic 600 oven distributed by Blue M Electric Company of Blue Island, Ill. Upon completion of the equilibration, the pans are removed from the oven, weighed and immediately returned to the oven. After 24 hours, the pans are removed from the oven and weighed again. The preliminary test water vapor transmission rate values are calculated as follows: Test MVTR=(grams weight loss over 24 hours)×(315.5 g/m² per 24 hours). The relative humidity within the oven is not specifically controlled. Under predetermined set conditions of ˜95-100° F. (˜32-37° C.) and ambient relative humidity, the MVTR for the “CELGARD” 2500 control has been defined to be 5000 grams per square meter for 24 hours. Accordingly, the control sample was run with each test and the preliminary test values were corrected to set conditions using the following equation: MVTR=(test MVTR/control MVTR)×(5000 g/m² per 24 hrs.).

The term “conjugate fibers” as used herein refers to fibers that have been formed from at least two polymers extruded from separated extruders but spun together to form one fiber. Conjugate fibers are also sometimes referred to as multicomponent or bicomponent fibers. The polymers are usually different from each other though conjugate fibers may be monocomponent fibers. The polymers are arranged in substantially instantly positioned distinct zones across the cross-section of the conjugate fibers and extend continuously along the length of the conjugate fibers. The configuration of such a conjugate fiber may be, for example, a sheath/core arrangement, wherein one polymer is surrounded by another or may be a side by side arrangement, a pie arrangement or an “islands-in-the-sea” arrangement. Conjugate fibers are taught by U.S. Pat. No. 5,108,820 to Kaneko et al., and U.S. Pat. No. 4,795,668 to Krueger et al., U.S. Pat. No. 5,336,552 to Strack et al. Conjugate fibers are also taught in U.S. Pat. No. 5,382,400 to Pike et al. and may be used to produced crimp in the fibers by using the differential rates of expansion and contraction of the two (or more) polymers. Crimped fibers may also be produced by mechanical means and by the process of German Patent DT 25 13 251 A1. For two component fibers, the polymers may be present in ratios of 75/25, 50/50, 25/75, or any other desired ratios. The fibers may also have shapes such as those described in U.S. Pat. No. 5,277,976 to Hogle et al. U.S. Pat. No. 5,466,410 to Hill, U.S. Pat. Nos. 5,069,970 and 5,057,368 to Largman et al., which describe fibers with unconventional shapes.

The term “continuous” or “substantially continuous” with respect to a filament or fiber refers a filament or fiber having a length much greater than its diameter, for example having a diameter to length ratio of about 1 to 2,000 or 3,000, or greater, desirably in excess of about 1 to 5,000, 15,000 or 25,000.

The term “disposable article” refers to a single or limited use article that is made from relatively inexpensive materials that make the article cost effective to fabricate. The technical, material, and economical problems associated with disposable articles are different from articles that can be used multiple times or reused, and as such have been constructed from relatively expensive materials.

The terms “elastic” and “elastomeric” as used herein are interchangeable and generally refer to materials that, upon application of a deforming stress or force, are stretchable in at least one direction (e.g., CD direction), and which upon release of the force returns to approximately its original size and shape. For example, a stretched material having a stretched length which is at least 5-20% greater than its relaxed unstretched length, and which will recover to within at least 5-20% of its original length upon release of the stretching, biasing force.

The term “filament” as used herein refers to a generally continuous strand that has a large ratio of length to diameter, such as, for example, a ratio of about 500-1000 or more.

The term “laminate” or “lamination” as used herein refers to a composite structure of two or more sheet material layers that have been adhered through a bonding step, such as through adhesive bonding, thermal bonding, point bonding, pressure bonding, extrusion coating, or ultrasonic bonding.

The term “machine direction” or MD means the length of a web in the direction in which it is produced. The term “cross machine direction” or CD means the width of fabric, i.e. a direction generally perpendicular to the MD.

The term “meltblown fibers” refers to fibers formed by extruding a molten thermoplastic material through a plurality of fine, usually circular, die capillaries as molten threads or filaments into converging high velocity, usually hot, gas (e.g. air) streams which attenuate the filaments of thermoplastic material to reduce their diameter, which may be to microfiber diameter. Thereafter, the meltblown fibers are carried by the high velocity gas stream and are deposited on a collecting surface to form a web of randomly disbursed meltblown fibers. Such a process is disclosed, for example, in U.S. Pat. No. 3,849,241 to Butin et al. Meltblown fibers are microfibers which may be continuous or discontinuous, are generally smaller than about 8-10 microns (μm) in average diameter, and are generally tacky when deposited on a collecting surface.

As used herein, the term “microporous film” or “microporous filled film” means films which contain filler material which enables development or formation of micropores in the film during stretching or orientation of the film.

The term “monolithic” is used to mean “non-porous”, therefore a monolithic film is a non-porous film. Rather than holes produced by a physical processing of the monolithic film, the film has passages with cross-sectional sizes on a molecular scale formed by a polymerization process. The passages serve as conduits by which water molecules (or other liquid molecules) can disseminate through the film. Vapor transmission occurs through a monolithic film as a result of a concentration gradient across the monolithic film. This process is referred to as activated diffusion. As water (or other liquid) evaporates on the body side of the film, the concentration of water vapor increases. The water vapor condenses and solubilizes on the surface of the body side of the film. As a liquid, the water molecules dissolve into the film. The water molecules then diffuse through the monolithic film and re-evaporate into the air on the side having a lower water vapor concentration.

A “moisture barrier” refers to any material that is relatively impermeable to the transmission of liquid fluids, i.e. a fabric having a moisture barrier can have a blood strikethrough ratio of about 1.0 or less according to ASTM test method 22.

The term “neck-bonded” refers to an elastic member being bonded to a non-elastic member while the non-elastic member is extended in the machine direction creating a necked material. “Neck-bonded laminate” refers to a composite material having at least two layers in which one layer is a necked, non-elastic layer and the other layer is an elastic layer thereby creating a material that is elastic in the cross direction. Examples of neck-bonded laminates are such as those described in U.S. Pat. Nos. 5,226,992, 4,981,747, 4,965,122, and 5,336,545, all to Morman, all of which are incorporated herein by reference.

The term “nonwoven web” or “nonwoven fabric” refers to a web having a structure of individual fibers or threads which are interlaid, but not in an identifiable manner as in a knitted fabric. Nonwoven webs or fabrics have been formed from many processes, such as, for example, meltblowing processes, spunbonding processes, and bonded carded web processes. The basis weight of nonwoven fabrics is usually expressed in ounces of material per square yard (osy) or grams per square meter (gsm) and the fibers diameters are usually expressed in microns. (Note that to convert from osy to gsm, multiply osy by 33.91). Nonwoven webs or fabrics may be used interchangeably and are distinguishable from flocking or other collection of individual fibers that do not form a unitary structure.

The term “polymer” generally includes, but is not limited to, homopolymers, copolymers, such as for example, block, graft, random and alternating copolymers, terpolymers, etc. and blends and modifications thereof. Furthermore, unless otherwise specifically limited, the term “polymer” includes all possible geometrical configurations of the molecule. These configurations include, but are not limited to isotactic, syndiotactic and random symmetries.

The terms “sheet” and “sheet material” shall be interchangeable and in the absence of a word modifier, refer to woven materials, non-woven webs, polymeric films, polymeric scrim-like materials, and polymeric foam sheeting.

The term “spunbond fiber” refers to small diameter fibers or filament materials that are formed by extruding molten thermoplastic material as filaments from a plurality of fine, usually circular capillaries of a spinneret with the diameter of the extruded filaments then being rapidly reduced as by, for example, in U.S. Pat. No. 4,340,563 to Appel et al., U.S. Pat. No. 3,692,618 to Dorschner et al., U.S. Pat. No. 3,802,817 to Matsuki et al., U.S. Pat. Nos. 3,338,992 and 3,341,394 to Kinney, U.S. Pat. No. 3,502,763 to Hartman, and U.S. Pat. No. 3,542,615 to Dobo et al. A “spunbond nonwoven web” refers to a fiber web formed from spunbond fibers, which are generally not tacky when they are deposited on a collecting surface. Spunbond fibers are generally continuous and have average diameters (from a sample of at least 10) larger than 7 microns (μm), and more particularly, between about 10 μm and 40 μm.

The term “stretch-bonded” as used herein refers to a composite material having at least two layers in which one layer is a gatherable layer and the other layer is an elastic layer. The layers are joined together when the elastic layer is in an extended condition so that upon relaxing the layers, the gatherable layer is gathered. For example, one elastic member can be bonded to another member while the elastic member is extended at least about 25% of its relaxed length. Such a multilayer composite elastic material may be stretched until the non-elastic layer is fully extended. One type of stretch-bonded laminate is disclosed, for example, in U.S. Pat. No. 4,720,415 to Vander Wielen et al., which is incorporated herein by reference. Other composite elastic materials are described and disclosed in U.S. Pat. No. 4,789,699 to Kieffer et al., U.S. Pat. No. 4,781,966 to Taylor, U.S. Pat. No. 4,657,802 to Morman, and U.S. Pat. No. 4,655,760 to Morman et al., all of which are incorporated herein by reference.

The term “texturized” as used herein refers to a base web having projections from a surface of the web in the Z-direction. The projections can have a length, for instance, from about 0.1 mm to about 25 mm, particularly from about 0.1 mm to about 5 mm, and more particularly from about 0.1 mm to about 3 mm. The projections can take on many forms and can be, for instance, bristles, tufts, loop structures such as the loops used in hook and loop attachment structures, and the like.

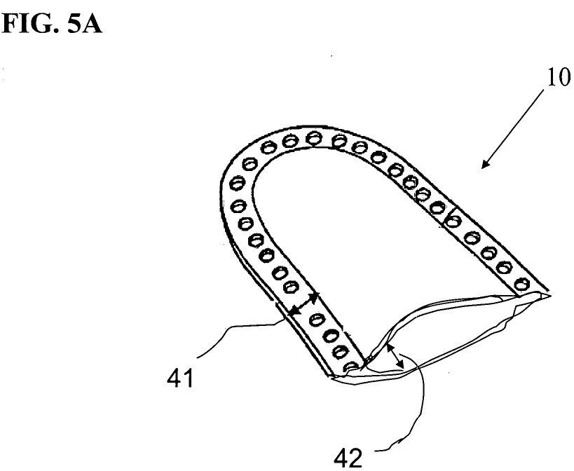

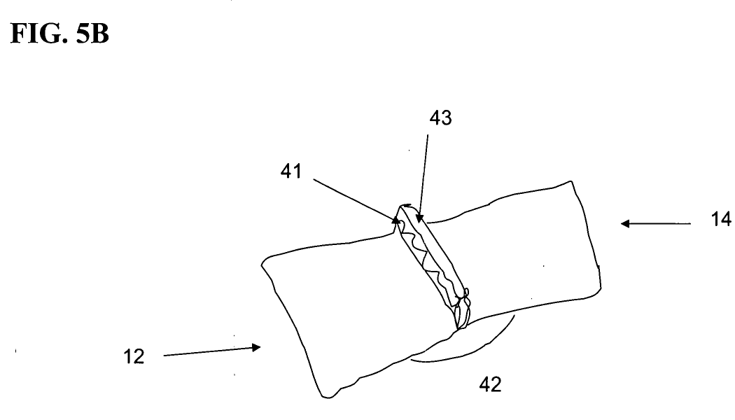

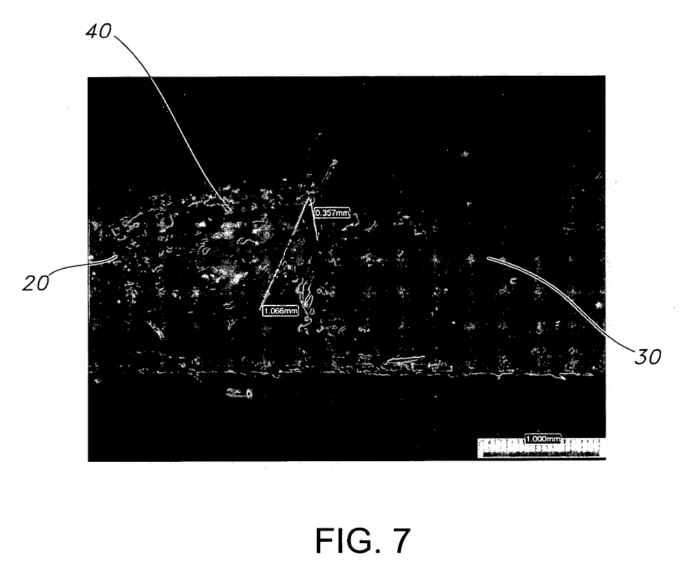

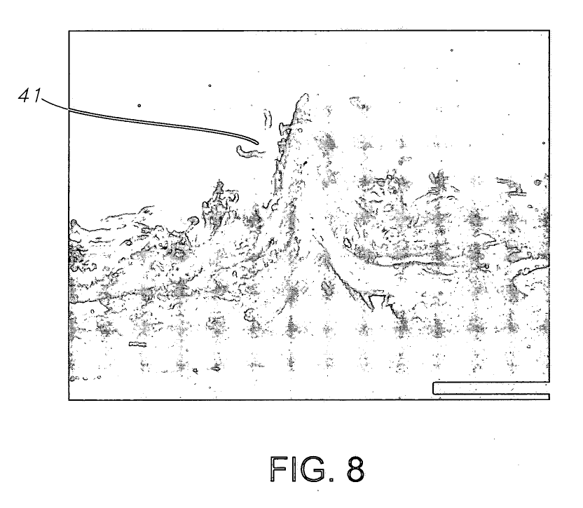

The term “stiff seam” refers to a seam that is at least about 1 mm in width. The term “flush seam” refers to a seam of up to about 1 mm in width. The terms seam width (or height) and thickness are defined in reference to FIGS. 5-8. As shown in FIGS. 5A, a seam can be defined by its width and thickness if the glove is in a flat shape (i.e., the angle between two connected pieces of fabrics is zero). The wider of the seam, the more stiff the seam tends to become. For example, if the article is opened up so that the angle 42 between the two panels 12, 14 of fabric is about 180 degrees, for instance, as shown in FIGS. 5B or FIGS. 6-8, the seam line becomes largely perpendicular to the two bonded fabrics, and the width of the seam then becomes the height of the seam. The height of the seam can be defined by the projected height of the seam in z-axis direction. More specifically, the flush seam line in the current invention is less than about 1 millimeter (mm) in width and about 1 mm in height. According to certain embodiments, the seam may desirably is less than about 500 μm in width and less than about 500 μm in height. Desirably, the seam can be less than about 300 μm in width and less than about 300 μm in height. More preferably, the seam is less than about 100-200 μm in width and less than about 100-200 μm in height. Most desirably, the seam is less than about 50 μm in width and less than about 50 μm in height. One can control the width and height of the seam by varying the width and height of the finger glove pattern on the bonding horn or the sewing die.

### Section II—General Description

Skin is the largest organ of the human body, accounting for about 12% to 16% of body weight, and covers an area of 12 to 20 square feet. The skin has two basic functions. First, it acts as a sensory organ. Second, the skin acts as a barrier to protect the body against harmful or invasive elements of our surrounding environment, and against fluid loss and desiccation. This barrier, however, must still be permeable enough to permit limited amount of excretion and regulate body temperature by evaporation.

Many people who have a need to use protective barrier articles, such as gloves or other garments, often experience skin problems since such articles encase human skin and does not breath. For example, surgical and medical exam glove are worn any time a healthcare worker comes in contact with a patient's bodily fluids, which can be occur, for example, when doing surgical procedures, or changing a dressing, a catheter, a bed pan, or bathing a patient, etc. These activities can take from as short as a couple of minutes up to many hours duration. Healthcare workers, on average, can wear about 10 to 15 pairs of gloves per an eight-hour period. As mentioned before, traditional protective barrier gloves have a low vapor transmission rate, so moisture from the hands becomes trapped next to the skin of the wearer. When the skin is occluded for long periods of time, it begins breakdown causing the skin damage that can lead to problems later on.

To overcome these and other problems, according to one aspect, the present invention provides, in part, protective articles or garments that are adapted to function more like skin—breathable but strong and protective against environmental conditions. Creation of protective articles according to the present invention involve forming a laminate from flexible sheet materials. The flexible sheet materials can provide desired skin-like barrier and elastic properties, while also improving the overall tactile aesthetics or feeling for the wearer, by reducing stiffness often found with nonwoven fabrics and the tackiness and difficult donning properties associated with latex-based substrates. The present invention functionally is like skin, in as much as a stretchable nonwoven web can provide tight, comfortable fit without sacrificing flexibility, while allowing for a relatively high rate of vapor or moisture transmission. Shaped fibers in the nonwoven fiber web can wick away moisture from a wear's skin; thus, preserving skin health. Additionally, given the particular structure of certain nonwoven fabrics, corrugation of the contact surface helps reduce the amount of surface area that actually contacts the wear's skin, making the article, if for example a glove, more ease to don or doff. The physical structure of nonwoven materials also can produce capillary action to wick moisture away from the wearer's skin; hence, removing any sense of wetness or clamminess and keeping the wear feeling dry and comfortable.

Nonwoven materials usually are not as compliant as woven cloth, soft leather, or elastomeric polymer lattices. That is, nonwoven materials do not bend or flex as well and tend to be stiff and unyielding, especially when worn on the body. To permit comfort and unrestrained movement without binding, protective garments made with nonwoven components tend to be oversized and baggy, which prevents them from fitting snuggly and conforming, for example, to a person's hand, foot, elbow or knee. Hence, nonwoven materials traditionally have not been considered for the fabrication of protective articles that need to fit tightly and still have good flexibility but without binding and constraining movement. Additionally, for sizing issues, nonwoven materials have not been widely adopted. With advances in manufacturing and bonding technologies, nonwoven materials that can have the feeling and function of woven cloth-like material can be adapted to make more flexible protective articles at relatively inexpensive cost.

It is envisioned that a protective article according to the present invention, can fill the gap between conventional durable gloves and foot covers and less expensive disposable articles. The nonwoven web will enable one to readily fabricate protective article using high-speed manufacturing techniques. It is believed that adaptation of stretchable, multi-directional elastic nonwoven webs for the present articles can provide both the advantage of a snug fit with flexibility, and reduce the amount of material used, which can translate to an economical saving in materials of about at least 5-10%. This can enable one to produce economically disposable articles for a single or limited use. The elastic nature of the nonwoven web permits it to be more readily moulded to conform with the three-dimensionality, for instance, of a hand in the case of a glove, which allows the hand to flex and move more naturally than in traditional flat-formed gloves.

In general, the articles of the present invention have at least a two-layer construction, with at least a polymer barrier layer and a nonwoven fiber layer. The particular configuration of the article will depend on the desired properties and its specific intended uses. For a three-layer article, such as a glove, both the outer and inner layers can be made from the same or different non-woven material and the middle layer, sandwiched in between, is an elastomeric membrane or other polymer film. The polymer layer preferably is an elastic and flexible plastic which can be stretched at least 10˜25% in any given direction or a desired direction either in x direction or in y direction, and has strong retractive forces as well. The inner and outer layers is an extensible, preferably elastic, preferably nonwoven material. The polymer layer is the primary barrier layer.

Gloves with more then three layers can have nonwoven and polymer film layers in any order as defined by predetermined desired protective properties. Desirably, the initial layer that contacts a wear's skin is the nonwoven layer, over which the barrier layer is adhered. Over the barrier layer may be another nonwoven layer or another barrier layer, each layer being either made from the same or, preferably, a different material to add or enhance the protective properties. All of the layers can be bonded together using a variety of either thermal, chemical, ultrasonic, or physical/mechanical means. Desirably the article forms a hollow body with an opening that fits snuggly without bunching at flex points, such as along the cures of the fingers or between individual digits of a glove, and without either slipping or binding too tightly against, for example, either a wrist or ankle for a glove or foot cover, respectively.

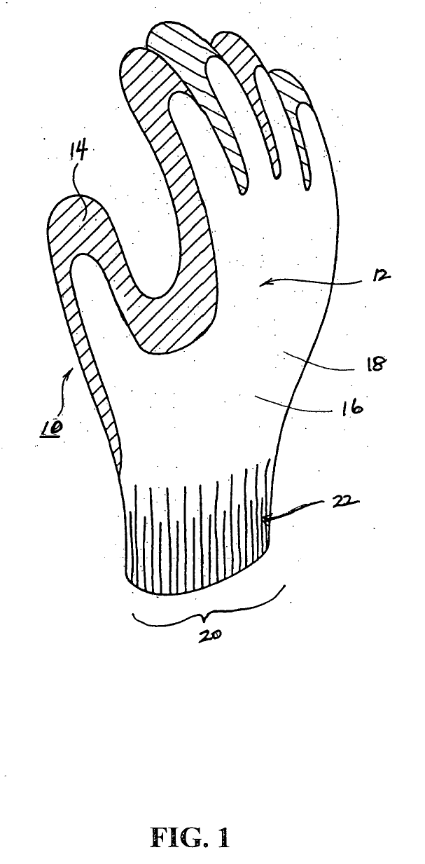

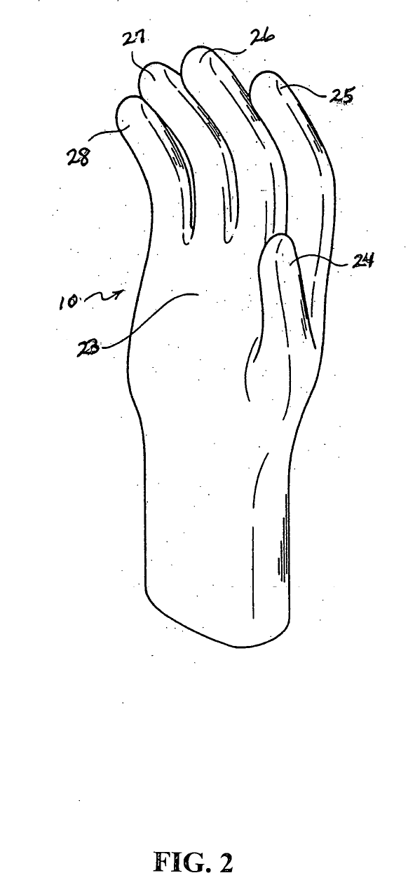

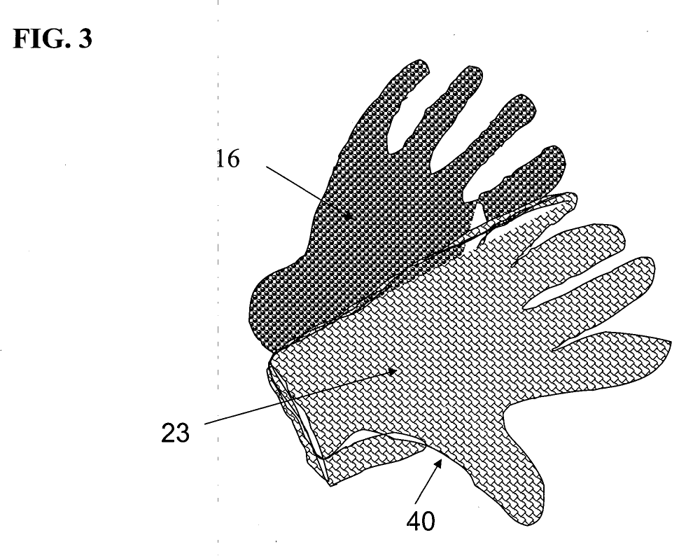

For example, as illustrated in FIG. 1, it is envisioned that in a two-layer glove 10, as the inner-most layer, the nonwoven fiber layer contacts a wear's skin while the polymer layer provides an exterior barrier. According to an embodiment of FIG. 1, the glove can have a first panel 12 attached to a second panel 14 forming a hollow enclosure. The first panel 12 is composed of at least a breathable, elastomeric, polymer, barrier layer 16 adhered to a stretchable, multidirectional elastic nonwoven fiber web 18, such that the barrier layer 16 covers at least a portion of said nonwoven fiber web 18. Desirably the barrier layer is coterminous with the nonwoven web. The second panel 14 may be composed of at least an elastic nonwoven fiber layer. Optionally, a barrier layer can also be applied to the second panel. FIG. 3 show an exploded view of a glove with the barrier layer 14 partially pealed back from the nonwoven layer 16. The first panel can be attached to the second panel in a manner that forms a seam. The nonwoven fiber webs of both first and second panels include continuous fibers. The cuff or wrist opening area 20 of the embodiment in FIG. 1 shows a series of gathers 22 that help maintain the fit of the glove 10 against the wear's hand and prevent slippage. The palm 23 of the glove 10, thumb 24 and each of the other four fingers 25, 26, 27, 28, as partially shown in FIG. 1, from the back, and full on in FIG. 2, can be subsequently coated with an elastomeric material 30, such as an overcoat made from a material selected from natural latex rubber, nitrile, vinyl, or styrene-ethylene-butylene-styrene (S-EB-S), or styrene-butadiene-styrene (SBS) polymer materials. The elastomeric coating is applied over at least a portion of the laminate construction, as illustrated in FIG. 1. That is, an impermeable elastomeric component can cover the palms of gloves and soles of foot wear, respectively, although the area on the back of the hand and top of the feet, respectively. This not to say that these areas may also have a coating of the elastomeric component, but for promoting breathable evaporation, it is desirable that the entire surface of the article is not covered. A portion of the back or the cuff area of the glove, for example, is left free of the non-breathable elastomeric material, which permits the nonwoven layer to remove perspiration and other moisture that have been wicked away from the skin. The moisture through the nonwoven fabric structural capillarity can be brought to the surface of the back of the hand and allowed to evaporate through the uncovered portion of the glove. In some embodiments, however, optionally, the elastomeric material may be applied over the entire glove, both palm-side and back of the hand.

In a glove or foot wear, for instance, the nonwoven layer may serve as either an underglove or a lining for barrier layer and elastomeric overcoat. The nonwoven fiber layer web separates and keeps the elastomeric material away from skin. A common problem associated with the wearing of articles or garments made from natural rubber latex over enclosed skin is the development of various skin allergies (e.g., irritant dermatitis, delayed cutaneous hypersensitivity (Type IV allergy), and immediate reaction (Type I allergy)) that are believed to be caused by proteins in the rubber latex. By using a non-woven liner, such allergy reactions can be minimized and/or eliminated by avoiding direct contact of skin with latex. Instead of being in contact with the latex rubber, a barrier will protect the wearer's skin, which will touch an inner surface that has a non-woven layer of long continguous fiber strands. The non-woven liner can provide a soft cloth or “cotton-like” feel that is significantly more comfortable for the wearer than direct skin contact with latex or plastic films. A nonwoven liner also provide additional advantages over unlined or naked latex gloves by absorbing moisture, and eliminating the convention requisite for specialized donning coats. Since a nonwoven fabric has a lower coefficient of friction relative to plastic films or latex membranes, a glove with an inner lining of nonwoven fabric can facilitate donning or doffing of the glove, permitting the user to easily slip a hand in or out of the glove. No cornstarch or talcum powder would be needed for such gloves, since the nonwoven layer is not tacky or resistent against damp human skin as rubber or other polymer latex compositions. A further advantage is that nonwoven fabric will not bind and chafe against the wearers' skin. In another concern, latex gloves are plagued by quality concerns arising from irregularities in thickness for different manufactures. The gloves of the present invention can also provide a more uniform thickness for comfort and better control, enhancing quality and reproducability during manufacture since the nonwoven web can be prefabricated.

Various types of polymer-based materials from the art may be used to make cloth-like non-woven fabrics. A foundational substrate or base nonwoven fiber web can be formed from materials that may include, for instance, synthetic fibers, pulp fibers, thermo-mechanical pulp, or mixtures of such materials such that the web has cloth-like properties. A flexible sheet material can be used to form the non-woven webs. Non-woven web materials suitable for use in the invention may be, for example, selected from a group consisting of spunbond, meltblown, spunbond-meltblown-spunbond laminates, coform, spunbond-film-spunbond laminates, bicomponent spunbond, bicomponent meltblown, biconstituent spunbond, biconstituent meltblown, bonded carded bicomponent web, crimped fibers airlaid and combinations thereof.

The base web can also include various elastomeric components, such as elastic laminates or film laminates. For example, suitable elastic laminates can include stretch-bonded and neck-bonded laminates. Alternatively, fibrous nonwoven webs formed by extrusion processes such as spunbonding and meltblowing, and by mechanical dry-forming process such as air-laying and carding, used in combination with thermoplastic film or microfiber layers, may be utilized as components. Since the materials and manufacture of these components of the present invention is often inexpensive relative to the cost of woven or knitted components, the products can be disposable.

Conventional materials As nonabsorbent articles, the protective articles of the present invention are configured to shield or cover at least a portion of the body of a wearer without trapping or absorbing substantial quantities of fluids. Nonabsorbent articles are distinguishable from, for example, diapers, adult incontinence articles, or sanitary napkins.

An article of the present invention typically includes an elastic component, such as to provide a glove or foot covering with form-fitting properties. For instance, a glove formed with an elastic component can snuggly fit onto a person's hand so that the glove can more effectively remain on the hand. The barrier film is adapted to remain “breathable” to aid in a person's comfort during use, while also remaining capable of substantially inhibiting the transfer of liquids from the outer surface of the glove to the person's hand.

The barrier layer can include a moisture barrier that is incorporated into or applied to the foundational substrate or base nonwoven web. In general, a moisture barrier refers to any barrier, layer or film that is relatively liquid-impervious. In particular, the moisture barrier of the present invention can prevent the flow of liquid through the glove so that the hand inserted therein remains dry when the glove is being used. In some embodiments, the moisture barrier can remain breathable, i.e., permeable to vapors, such that the hand within the glove is more comfortable. Examples of suitable moisture barriers can include films, fibrous materials, laminates, and the like. In particular, a layer of film or microfibers may be used to impart liquid barrier properties, and an elastic layer (e.g., elastic film or elastic microfibers) may be used to impart additional properties of stretch and recovery.

Films in general and elastic layers in particular, whether a film sheet layer or a microfiber layer, often have unpleasant tactile aesthetic properties, such as feeling rubbery or tacky to the touch, making them unpleasant and uncomfortable against the wearer's skin. Fibrous non-woven webs, on the other hand, have better tactile, comfort and aesthetic properties.

The tactile aesthetic properties of elastic films can be improved by forming a laminate of an elastic film with one or more non-elastic materials, such as fibrous non-woven webs, on the outer surface of the elastic material. Fibrous non-woven websformed from non-elastic polymers such as, for example polyolefins, however, are generally considered non-elastic and may have poor extensibility, and when non-elastic non-woven webs are laminated to elastic materials the resulting laminate may also be restricted in its elastic properties. Therefore, laminates of elastic materials with non-woven webs have been developed wherein the non-woven webs are made extensible by processes such as necking or gathering.

In accordance with the present invention, the non-woven fiber web can be porous and its fiber surface can be further modified to have a variety of different surface functionalities. For example, pores associated with the fiber web can be used a carrier for a variety of treatments in which various additives can be applied, if desired, to the whole or part of the glove before use. When used as a protection garment for dry skin, wounds, cuts, bruises, blisters, odor control, keeping hand or foot warm, etc. Various additives can be applied to the glove to aid for therapeutic purposes. Examples of such articles may include disposable, exam, surgical, clean room, work, and/or industrial protection gloves where added strength, comfort, skin protection, and powder-free aspects are desirable characteristics. For example, an article of the present invention can generally include additives such as antibiotics, anti-microbial agents, anti-inflammatory agents, NEOSPORIN, moisturizing agents, cationic polymers, and the like. In addition, when used as a glove for treating other ailments, such as arthritis; “black toe”, “trigger finger”; or jammed, sprained, hyper-extended, dislocated, or broken appendages, a glove of the present invention can generally include various other additives, such as topical analgesics (e.g. BEN-GAY®), anti-inflammatory agents, vasodilators, corticosteroids, dimethyl sulfoxide (DMSO), capsaicin, menthol, methyl salicylate, DMSO/capsaicin, cationic polymers, anti-fungal agents, and the like.

Additives can be applied to a glove of the present invention in the form of an aqueous solution, non-aqueous solution (e.g., oil), lotions, creams, suspensions, gels, etc. When utilized, the aqueous solution can, for example, be coated, sprayed, saturated, or impregnated into the glove. In some embodiments, the additives can be applied asymmetrically. Moreover, in some instances, it may be desired that the additives comprise less than about 100% by weight of the glove, and in some embodiments, less than about 50% by weight of the glove and particularly less than 10% by weight of the glove, and in some embodiments, less than about 5% by weight of the glove, and in some embodiments, less than about 1% by weight of the glove. It should be noted that any given range presented herein in intended to include any and all lesser included ranges. For example, a range from 45 to 90 would also include 50 to 90; 45.5 to 80; 75-89 and the like. In some embodiments, the glove may be treated with above said additives to only certain areas, particularly in areas that are desired to be treated. For example, a glove can have additives to only finger areas for being used as a finger appendage.

The non-woven web materials are preferably formed with polymers selected from the group including: polyolefins, polyamides, polyesters, polycarbonates, polystyrenes, thermoplastic elastomers, fluoropolymers, vinyl polymers, and blends and copolymers thereof. Suitable polyolefins include, but are not limited to, polyethylene, polypropylene, polybutylene, and the like; suitable polyamides include, but are not limited to, nylon 6, nylon 6/6, nylon 10, nylon 12 and the like; and suitable polyesters include, but are not limited to, polyethylene terephthalate, polybutylene terephthalate and the like. Particularly suitable polymers for use in the present invention are polyolefins including polyethylene, for example, linear low density polyethylene, low density polyethylene, medium density polyethylene, high density polyethylene and blends thereof; polypropylene; polybutylene and copolymers as well as blends thereof. Additionally, the suitable fiber forming polymers may have thermoplastic elastomers blended therein.

Non-woven fabrics which are used in such laminates, prior to conversion into such laminates, desirably have a basis weight between about 10 g/m² and 50 g/m² and even more desirably between about 12 g/m² and 25 g/m². In an alternative embodiment such non-woven fabrics have a basis weight between about 15 g/m² and 20 g/m².

Another flexible sheet material that may be used include polymeric films, which provide a barrier to fluids while remaining flexible. The films can be either micro-porous or monolithic. Micro-porous or monolithic films can be combined in the construction of the present protective articles. For instance, depending on the desired properties or use, one part of a gloves or foot cover can be made with micro-porous films (e.g., back of the hand of a glove, or upper body of a foot cover) while another part can be made with a monolithic film (e.g., palm and fingers, or foot sole), since each respective area of the article will have different demands place on its function and it may come in contact with different environmental conditions. In certain variations, to illustrate, often the palm and finger areas of a glove, like the sole of a foot covering, will be exposed to much wear and tear against abrasion or hard surfaces, as well as chemical or biological hazards, hence they need to be both resilient and impermeable to protect the wear. In contrast, the back of the hand and upper body of a foot cover are relatively sheltered from harsh use of treatment, hence a more breathable films is more suited. Examples of such films are described in WO 96/19346 to McCormack et al., incorporated herein by reference in its entirety. Also because of the exposure to abrasion, the palm and fingers of a glove can have a further elastomeric polymer overcoat to strength the barrier layers or protect the underlying nonwoven-laminate body of the glove or foot cover.

While it should be recognized that flexible sheet materials can be chosen from a broad spectrum of materials, non-woven webs and polymeric films are used hereunder for illustrative purposes. When a machine direction tension force is applied to an elastic film sheet, the force will cause the elastic film sheet to be stretched or elongated in the machine direction. Because the film sheet is elastic, when the tension is removed or relaxed the film will retract toward its original machine direction length. When the film retracts or becomes shorter in the machine direction, first fibrous nonwoven web and/or second fibrous nonwoven web which are bonded to the side or sides of the elastic film will buckle or form gathers. The gathers can be applied to form a cuff around an open end of the present protective articles. The resulting elastic laminate material is stretchable in the machine direction to the extent that the gathers or buckles in the fibrous nonwoven web or webs can be pulled back out flat and allow the elastic film to elongate.

A glove of the present invention can be generally formed in a variety of ways. For instance, in one embodiment, the glove can have a unitary structure from a single piece of fabric. In some embodiments, the glove can be formed from multiple sections. For example, some sections are more stretchable than others, and in some areas are more resilient, hence stronger than others. Each section can be identical or different, depending on the desired characteristics of the glove. For example, in one embodiment, the glove is formed from at least two non-identical sections, wherein one section is formed from a nonwoven material and the other section is formed from an elastomeric nonwoven material. In other embodiments, the glove can be formed from two or more sections of base web material.

Protective articles according to the present invention may have stiff or soft flush seams, depending upon the type of materials used and the strength requirements for the seam. As used herein, the term “stiff seam” refers to a seam has a width greater than 1 mm. In some iterations, the seam width can be as much as 10 mm. The “flush seam” refers to a seam line that is less than about 1 mm. Typically, the flush seam is less than about 500 micrometers (μm) in width and about 500 μm in height. Often, the seam is less than 400 or 300 μm in width and 400 or 300 μm in height. Preferably, the seam is less than 100 μm in width and 100 μm in height. In certain preferred embodiments, the seam width can be as narrow as about 50 μm. The width and height of the seam can be controlled, for instance, by varying the width and height of the finger glove pattern on the bonding horn or bonding anvil, or ultrasonic sewing die.

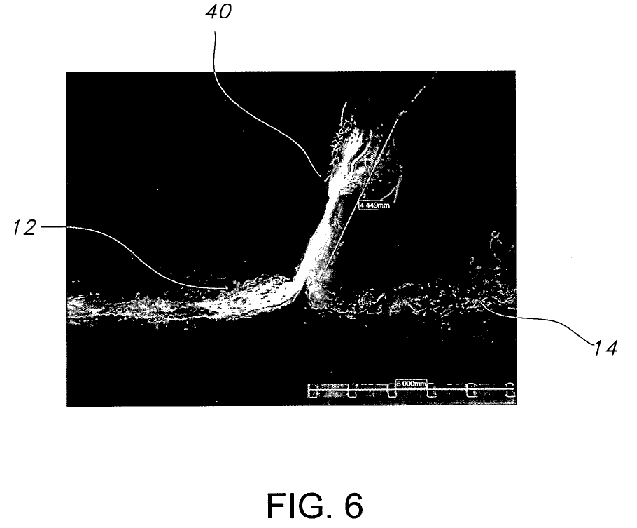

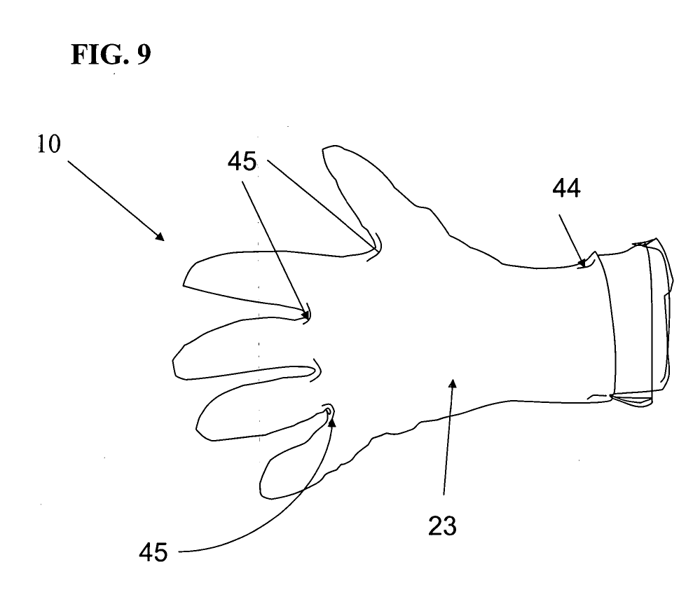

An example of a stiff and flush type of seam can be seen in the photo illustrations of FIGS. 5 and 6, respectively. As shown in FIGS. 5 and 5 seam lines can be defined by their width 41 and thickness 43 if the glove is placed in a flat shape (the angle 42 between two connected fabrics is ˜zero). A wide seam creates a seam will relatively low stiffness. Hence, the wider the seam, the lesser the stiffness of the seam. For example, if the angle 42 between two fabrics is about 180 degrees, as shown in FIG. 6, the seam line becomes perpendicular to the two bonded fabrics, and the width 41 of the seam, such as in FIGS. 5A and 5B, becomes the height of the seam, as in FIG. 6. The height of the seam 41 can be defined by the projected height of the seam to z-direction. To further enhance the sealing and reduce the possibility of the seam line opening during glove handling, hand insertion, and during use, extra bonding points 44 and 45 can be placed at the weak bonding areas, as depicted in FIG. 9. The extra bonding points 44 and 45 can be made in any shape, but preferably in a shape that can help the user to place the glove onto the hand.

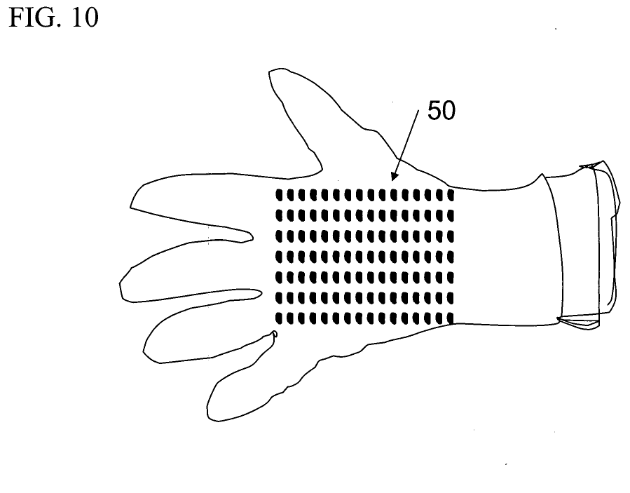

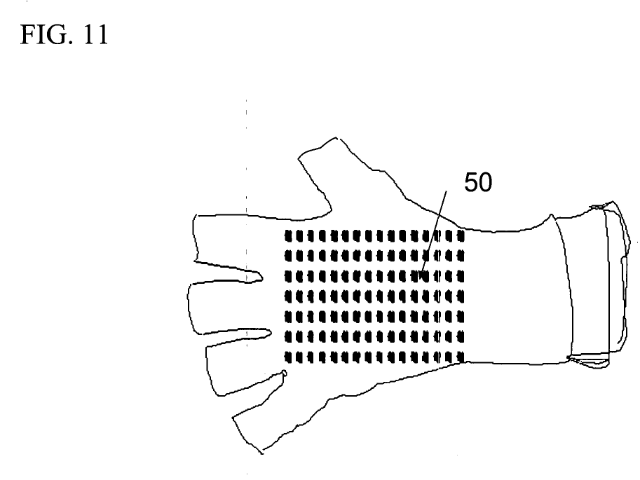

In another aspect, the present invention discloses a method or alternative process to make fiber reinforced disposable gloves or foot covers. The method involves the steps of: providing a base material having at least a first nonwoven fiber layer and a first breathable barrier layer; applying the base material to a mould and die, such that the nonwoven fiber layer is configured to become an inner lining for an article; forming a hollow body article and sealing any seams. In some embodiments, where an overcoat of a polymeric elastomer material is desired, the nonwoven-web-and-barrier-layer laminate body can be fitted over a hand or foot shaped mould. Once the laminate base material is positioned on the mould, and the seams of the article are sealed, the process may further involve dipping the mould into a bath of elastomeric material, such as nature or synthetic latex or other polymeric solution or emulsions, to form an impermeable coating over at least a portion of the article. Alternatively, one can employ conventional fine-spray techniques to make an elastomeric or any other kind of coating on the hollow body article. The elastomeric coating can be in the form of a pattern, such as shown in FIGS. 10 and 11, on a glove over the palm and finger areas.

Various additives can be applied to the protective article of the current invention to provide therapeutic uses and address a variety of appendage ailments and injuries have continuously plagued people over the years. For example, fingers and toes can become wounded, cut, or blistered. And, joints of fingers and toes can suffer from a number of ailments, such as arthritis or carpal tunnel syndrome, or become jammed, sprained, hyper-extended, dislocated, or broken. Fingers and toes can also be afflicted with warts, or corns, or toenails can frequently suffer from fungal infection, referred to as onychomycosis, or “blacktoe,” the result of repetitive, forceful striking of the end of a shoe or boot with a toenail, and long-time ailment of hikers, athletes, joggers, and others.

### Section III—Components

The present invention will be described in reference to the accompanying FIGS. 1-12, which depict various embodiments of a glove. A glove of the present invention can be as a disposable article, but a glove of the present invention is not limited necessarily to disposable embodiments, but also to durable industrial gloves. In other embodiments, the present invention can also be configured for constructing a foot protection garment. In terms of materials and general construction, a foot cover of the present invention is essentially identical to a hand glove, except for difference in shape of the foot cover to better fit the contours of a human foot.

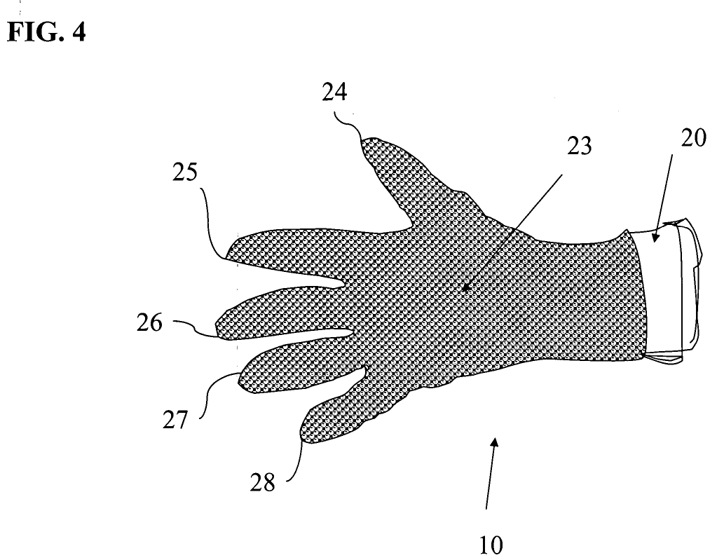

In FIG. 4, the glove 28 has a body formed from laminate structure of at least a nonwoven fiber web 17 with substantially continuous fibers and an elastic barrier layer. Optionally, one may apply to the fingers 24-28 and palm 23 an overcoat 19 of either a natural or synthetic elastomeric polymer or resin for extra protection. Around the wrist area 20, one can have an elastic region or band made from necked fiber meshes that have a predominate unidirectional stretch. According to an embodiment, the glove can be formed as a unitary structure from a single piece of nonwoven fabric. A wearer of the glove can maneuver the glove over the hand until the glove fits comfortably. Any other shape can be employed in the present invention as long as a hand can be inserted through. The size and length of the glove can vary depending on the size of the hand and the desired use for the glove. Although not required, in some variations, the glove can have a slightly tapered shape, in which the ends of finger sections are narrower to better conform to the contours of the finger. In some cases such as shown in FIG. 11, the tight fit to the hand, particularly for fingers at the open end can serve as a blockage for preventing materials such as dirt or oil and the like into the other parts of the hand.

To soften the feel of the stiff seams of a glove during use, a plurality of cuts can be made along the edges of the seam. The cuts, which can be referred to as microcuts, can be narrowly spaced along the seam. The cuts can be, for instance, less than 1 cm apart, particularly less than about 0.5 cm apart, and more particularly, less than about 1 mm apart. The cuts can extend substantially the entire width of the seam. For instance, the length of the cuts can be from about 0.1 cm to about 0.5 in length depending upon the particular application. The microcuts can be formed into the seam using any suitable process. For instance, the cuts can be made using cutting dyes, laser technology, ultrasonic knives, and the like.

In other embodiments, the glove can also be turned inside-out such that the seams are located inside the glove. Moreover, the seams can also provide a better fit by providing more friction to the hand. In addition, in some embodiments, this “inside-out” position can enable the glove to be more resistant to “flattening out” during use, particularly at the finger area.

A. Nonwoven Fiber Layer

In general, the glove of the present invention can be formed from a variety of materials. For instance, as stated above, the glove can be formed as a unitary structure from a base web. Alternatively, the glove can be formed from two sections made from the same or different base webs. A base web, as used herein, refers to a substrate that include one or more layers of fibrous materials. For most applications, gloves made according to the present invention are constructed for nonwoven webs containing an elastic component referred to herein as an “elastic nonwoven.” An elastic nonwoven is a nonwoven material having non-elastic and elastic components or having purely elastic components. The elastic component can form a separate section of the glove. For example, the glove can be made from two or more sections of material that includes a first section made from a non-elastic material and a second section made from an elastic material. Alternatively, the glove can be made from a single piece of material that contains an elastic component. For example, the elastic component can be a film, strands, non-woven webs or elastic filament incorporated into a laminate structure.

Non-elastic materials used in the present invention typically include nonwoven webs or films. The nonwoven webs, for instance, can be meltblown webs, spunbond webs, carded webs and the like. The webs can be made from various fibers, such as synthetic or natural fibers. For instance, in one embodiment, synthetic fibers such as fibers made from thermoplastic polymers, can be used to construct the glove of the present invention. For example, suitable fibers could include melt-spun filaments, staple fibers, melt-spun multicomponent filaments, and the like.

Synthetic fibers or filaments used in making the nonwoven materials of the base web have any suitable morphology that may include hollow or solid, straight or crimped, single component, conjugate or biconstituent fibers or filaments, and blends or mixtures of such fibers and/or filaments, as are well known in the art.

The synthetic fibers used in the present invention may be formed from a variety of thermoplastic polymers where the term “thermoplastic polymer” refers to a long chain polymer that repeatedly softens when exposed to heat and substantially returns to its original state when cooled to ambient temperature. As used herein, the term “polymer” generally includes, but is not limited to, homopolymers, copolymers, such as for example, block, graft, random, and alternating copolymers, terpolymers, etc., and blends and modifications thereof. As used herein, the term “blend” means a mixture of two or more polymers. Furthermore, unless otherwise specifically limited, the term “polymer” shall include all possible geometrical configurations of the molecule. These configurations include, but are not limited to, isotatic, synditatic, and random symmetries.

Exemplary thermoplastics include, without limitation, poly(vinyl) chlorides, polyesters, polyamides, polyfluorocarbons, polyolefins, polyurethanes, polystyrenes, poly(vinyl) alcohols, caprolactams, and copolymers of the foregoing, and elastomeric polymers such as elastic polyolefins, copolyether esters, polyamide polyether block copolymers, ethylene vinyl acetates (EVA), block copolymers having the general formula A-B-A′ or A-B like copoly(styrene/ethylene-butylene), styrene-poly(ethylene-propylene)-styrene, styrene-poly(ethylene-butylene)-styrene, (polystyrene/poly(ethylene-butylene)/polystyrene, poly(styrene/ethylene-butylene/styrene), A-B-A-B tetrablock copolymers and the like.

Many polyolefins are available for fiber production, for example polyethylenes such as Dow Chemical's PE XU 61800.41 linear low density polyethylene (“LLDPE”) and 25355 and 12350 high density polyethylene (“HDPE”) are such suitable polymers. Fiber-forming polypropylenes include Exxon Chemical Company's Escorene™ PD 3445 polypropylene and Montell Chemical Co.'s PF-304 and PF-015. Many other conventional polyolefins are commercially available and include polybutylenes and others.

Examples of polyamides and their methods of synthesis may be found in “Polymer Resins” by Don E. Floyd (Library of Congress Catalog No. 66-20811, Reinhold Publishing, New York, 1966). Particularly commercially useful polyamides are nylon-6, nylon 6,6, nylon-11 and nylon-12. These polyamides are available from a number of sources such as Emser Industries of Sumter, South Carolina (Grilon™ & Grilamid™ nylons), Atochem Inc. Polymers Division of Glen Rock, N.J. (Rilsan™ nylons), Nyltech of Manchester, N.H. (grade 2169, Nylon 6), and Custom Resins of Henderson, Ky. (Nylene 401-D), among others.

Synthetic fibers added to the base web can also include staple fibers which are added to increase the strength, bulk, softness and smoothness of the base sheet. Staple fibers can include, for instance, various polyolefin fibers, polyester fibers, nylon fibers, polyvinyl acetate fibers, cotton fibers, rayon fibers, non-woody plant fibers, and mixtures thereof. In general, staple fibers are typically longer than pulp fibers. For instance, staple fibers typically have fiber lengths of 5 mm and greater. Staple fibers can increase the strength and softness of the final product.

The fibers used in a base web of the present invention can also be curled or crimped. The fibers can be curled or crimped, for instance, by adding a chemical agent to the fibers or subjecting the fibers to a mechanical process. Curled or crimped fibers may create more entanglement and void volume within the web and further increase the amount of fibers oriented in the z-direction as well as increase web strength properties.

The synthetic fibers added to the base web can also include bicomponent fibers. Bicomponent fibers are fibers that can contain two materials such as but not limited to in a side by side arrangement, in a matrix-fibril arrangement, wherein a core polymer has a complex cross-sectional shape, or in a core and sheath arrangement. In a core and sheath fiber, generally the sheath polymer has a lower melting temperature than the core polymer to facilitate thermal bonding of the fibers. For instance, the core polymer, in one embodiment, can be nylon or a polyester, while the sheath polymer can be a polyolefin such as polyethylene or polypropylene. Such commercially available bicomponent fibers include “CELBOND” fibers marketed by the Hoechst Celanese Company.

Besides or in addition to synthetic fibers, pulp fibers can also be used to construct the appendage sleeve of the present invention. The pulp fibers used in forming the base web may be soft wood fibers having an average fiber length of greater than 1 mm, and particularly from about 2 to 5 mm based on a length weighted average. Such fibers can include northern softwood craft fibers, redwood fibers, and pine fibers. Secondary fibers obtained from recycled materials may also be used. In addition, hardwood pulp fibers, such as eucalyptus fibers, can also be utilized in the present invention.

Besides the above-mentioned fibers, thermomechanical pulp fibers can also be added to the base web. Thermomechanical pulp, as is known to one skilled in the art, refers to pulp that is not cooked during the pulping process to a lesser extent than conventional pulps. Thermomechanical pulp tends to contain stiff fibers and has higher levels of lignin. Thermomechanical pulp can be added to the base web of the present invention in order to create an open pore structure, thus increasing bulk and absorbency and improving resistance to wet collapse. When present, thermomechanical pulp can be added to a layer of the base web in an amount less than about 30%, desirably less than about 20, more desirably less than about 10%, by weight of the fibers contained in the layer. The lower the amount of the pulp, the better the wicking of moisture from a wearer's skin. When using thermomechanical pulp, a wetting agent is also preferably added during formation of the web. The wetting agent can be added in an amount less than about 1% by weight of the fibers and, in one embodiment, can be a sulphonated glycol.

When pulp fibers are used to form the base web, the web can be treated with a chemical debonding agent to reduce inner fiber-to-fiber strength. Suitable debonding agents that may be used in the present invention when the base web contains pulp fibers include cationic debonding agents such as fatty dialkyl quaternary amine salts, mono fatty alkyl tertiary amine salts, primary amine salts, imidazoline quaternary salts, and unsaturated fatty alkyl amine salts. Other suitable debonding agents are disclosed in U.S. Pat. No. 5,529,665 to Kaun, which is incorporated herein by reference. In one embodiment, the debonding agent can be an organic quaternary ammonium chloride. In this embodiment, the debonding agent can be added to the fiber slurry in an amount from about 0.1% to about 1% by weight, based on the total weight of fibers present within the furnish.

Moreover, in some embodiments of the present invention, a base web of the present invention can also be hydraulically entangled (or hydroentangled) to provide further strength. Hydroentangled webs, which are also known as spunlace webs, refer to webs that have been subjected to columnar jets of a fluid that cause the fibers in the web to entangle. Hydroentangling a web typically increases the strength of the web. Thus, according to the present invention, in order to increase the strength of a web, a base web of the present invention can be hydroentangled. For example, in one embodiment, the base web can comprise HYDROKNIT™, a nonwoven composite fabric that contains 70% by weight pulp fibers that are hydraulically entangled into a continuous filament material. HYDROKNIT™ material is commercially available from Kimberly-Clark Corporation of Neenah, Wis. Hydraulic entangling may be accomplished utilizing conventional hydraulic entangling equipment, such as may be found in, for example, in U.S. Pat. No. 3,485,706 to Evans or U.S. Pat. No. 5,389,202 to Everhart, et al., the disclosures of which are hereby incorporated by reference.

As mentioned above, for most application, non-woven webs used to construct the glove will contain synthetic fibers. For non-woven webs containing substantial amounts of synthetic fibers, the webs may be bonded or otherwise consolidated in order to improve the strength of the web. Various methods may be utilized in bonding webs of the present invention. Such methods include through air bonding and thermal point bonding as described in U.S. Pat. No. 3,855,046 to Hansen, et al., which is incorporated herein by reference. In addition, other conventional means of bonding, such as oven bonding, ultrasonic bonding, hydroentangling, are combinations of such techniques, may be utilized in certain instances.

In one embodiment, thermal point bonding is used which bonds the fibers together according to a pattern. In general, the bonding areas for thermal point bonding, whether pattern unbonded or pattern bonded fabrics, can be in the range of 50% total bond area or less.

More specifically, the bond areas of the present inventive webs can be in the range of 40% total bond area or less. Even more specifically, the bond areas can be in the range of 30% total bond area or less and may be in the range of about 15% total bond area or less. Typically, a bond area of at least about 10% can be acceptable for creating the base webs of the present invention, although other total bond areas will fall within the scope of the invention, depending on the particular characteristics desired in the final product. Stated generally, the lower limit on the percent bond area suitable for forming the nonwoven material of the present invention is the point at which fiber pull-out excessively reduces the surface integrity and durability of the material. The percent bond areas will be affected by a number of factors, including the type(s) of polymeric materials used in forming the fibers or filaments of the nonwoven web, whether the nonwoven web is a single- or multi-layer fibrous structure, and the like. Bond areas ranging from about 1% to about 50%, desirably from about 15% to 50%, have been found suitable for pattern or point unbonded webs (PUB), such as described in U.S. Pat. No. 5,858,515, the content of which is incorporated herein by reference.

B. Barrier Layer and Elastomeric Component

As described above, besides containing various nonwoven or non-elastic materials, the glove of the present invention can also contain an elastomeric component. By containing such an elastomeric component, the glove of the present invention can better fit around a hand, particularly at fingers and toes.

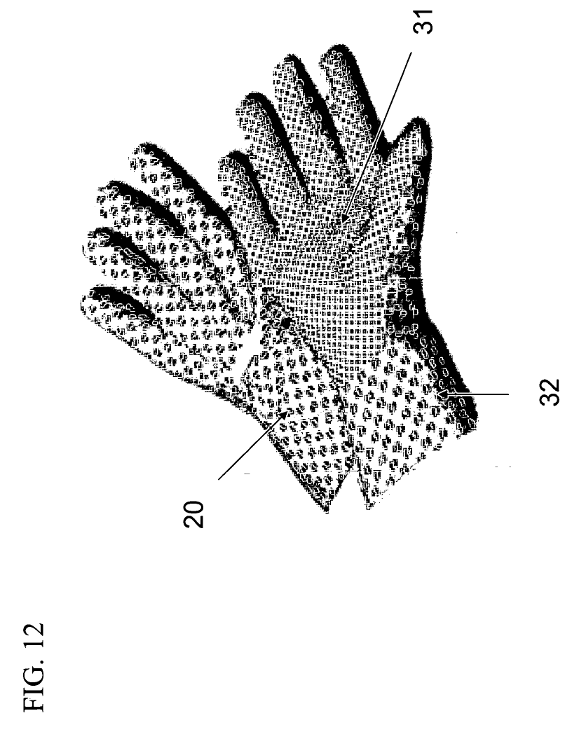

In this regard, referring to FIG. 3, one embodiment of the present invention is depicted that includes a glove made from a base web having at least one elastomeric component. In particular, the glove can be formed into a unitary structure from a base web that includes an elastomeric material. Moreover, in other embodiments, such as shown in FIG. 12, one side of the glove or part of the glove can include an elastomeric component.

When present in the glove, the elastomeric component can take on various forms. For example, the elastomeric component can be elastic strands or sections uniformly or randomly distributed throughout the base web. Alternatively, the elastomeric component can be an elastic film or an elastic non-woven web. The elastomeric component can also be a single layer or a multilayered material.

In general, any material known in the art to possess elastomeric characteristics can be used in the present invention as an elastomeric component. Useful elastomeric materials can include, but are not limited to, films, foams, nonwoven materials, etc. For example, suitable elastomeric resins include block copolymers having the general formula A-B-A′ or A-B, where A and A′ are each a thermoplastic polymer endblock which contains a styrenic moiety such as a poly(vinyl arene) and where B is an elastomeric polymer midblock such as a conjugated diene or a lower alkene polymer. Block copolymers for the A and A′ blocks, and the present block copolymers are intended to embrace linear, branched and radial block copolymers. In this regard, the radial block copolymers may be designated (A-B)m-X, wherein X is a polyfunctional atom or molecule and in which each (A-B)m-radiates from X in a way that A is an endblock. In the radial block copolymer, X may be an organic or inorganic polyfunctional atom or molecule and m is an integer having the same value as the functional group originally present in X. It is usually at least 3, and is frequently 4 or 5, but not limited thereto. Thus, in the present invention, the expression “block copolymer,” and particularly “A-B-A” and “A-B” block copolymer, is intended to embrace all block copolymers having such rubbery blocks and thermoplastic blocks as discussed above, which can be extruded (e.g., by meltblowing), and without limitation as to the number of blocks.

The elastomeric component may be formed from, for example, elastomeric (polystyrene/poly(ethylene-butylene)/polystyrene) block copolymers. Commercial examples of such elastomeric copolymers are, for example, those known as KRATON™ materials which are available from Krayton Polymer Inc. of Houston, Tex. KRATON™ block copolymers are available in several different formulations, a number of which are identified in U.S. Pat. Nos. 4,663,220, 4,323,534, 4,834,738, 5,093,422 and 5,304,599, which are incorporated herein by reference.

Polymers composed of an elastomeric A-B-A-B tetrablock copolymer may also be used in the practice of this invention. Such polymers are discussed in U.S. Pat. No. 5,332,613 to Taylor et al. In such polymers, A is a thermoplastic polymer block and B is an isoprene monomer unit hydrogenated to substantially a poly(ethylene-propylene) monomer unit. An example of such a tetrablock copolymer is a styrene-poly(ethylene-propylene)-styrene-poly(ethylene-propylene) or SEPSEP elastomeric block copolymer available from Krayton Polymer Inc. of Houston, Tex. under the trade designation KRATON™ G-1657.

Other exemplary elastomeric materials which may be used include polyurethane elastomeric materials of the general structure of -(AB)ₙ-, such as, for example, those available under the trademark ESTANE™ from B.F. Goodrich & Co. or MORTHANE™ from Morton Thiokol Corp., polyester elastomeric materials such as, for example, those available under the trade designation HYTREL™ from E.I. DuPont De Nemours & Company, and those known as ARNITEL™ formerly available from Akzo Plastics of Amhem, Holland and now available from DSM of Sittard, Holland.

Elastomeric polymers can also include copolymers of ethylene and at least one vinyl monomer such as, for example, vinyl acetates, unsaturated aliphatic monocarboxylic acids, and esters of such monocarboxylic acids. The elastomeric copolymers and formation of elastomeric nonwoven webs from those elastomeric copolymers are disclosed in, for example, U.S. Pat. No. 4,803,117.

Commercial examples of such copolyester materials are, for example, those known as ARNITEL™, formerly available from Akzo Plastics of Amhem, Holland and now available from DSM of Sittard, Holland, or those known as HYTREL™ which are available from E.I. DuPont de Nemours of Wilmington, Del. Formation of an elastomeric nonwoven web from polyester elastomeric materials is disclosed in, for example, U.S. Pat. No. 4,741,949 to Morman et al. and U.S. Pat. No. 4,707,398 to Boggs.

Elastomeric olefin polymers are available from Exxon Chemical Company of Baytown, Tex. under the trade name VISTAMAXX™ or ACHIEVE™ for polypropylene based polymers and EXACT™ and EXCEED™ for polyethylene based polymers. Dow Chemical Company of Midland, Mich. has polymers commercially available under the name ENGAGE™ as well as VERSIFY™ polypropylene-based elastomers. ExxonMobil generally refers to their metallocene catalyst technology as “single site” catalysts while Dow refers to theirs as “constrained geometry” catalysts under the name INSIGHT™ to distinguish them from traditional Ziegler-Natta catalysts which have multiple reaction sites.

When incorporating an elastomeric component, such as described above, into a base web of the present invention, it is often desired that the elastomeric material form an elastic laminate with one or more other layers, such as foams, films, apertured films, and/or nonwoven webs. The elastic laminate generally contains layers that can be bonded together so that at least one of the layers has the characteristics of an elastic polymer. Examples of elastic laminates include, but are not limited to, stretch-bonded laminates and neck bonded laminates.

The elastic member used in neck bonded materials, stretch-bonded materials, stretch-bonded laminates, neck bonded laminates and in other similar laminates can be made from materials, such as described above, that are formed into films, such as a microporous film, fibrous webs, such as a web made from meltblown fibers, or foams. A film, for example, can be formed by extruding a filled elastomeric polymer and subsequently stretching it to render it microporous.

Fibrous elastic webs can also be formed from an extruded polymer. For instance, as stated above, in one embodiment the fibrous web can contain meltblown fibers. The fibers can be continuous or discontinuous. Meltblown fabrics have been conventionally made by extruding a thermoplastic polymeric material through a die to form fibers. As the molten polymer fibers exit the die, a high pressure fluid, such as heated air or steam, attenuates the molten polymer filaments to form fine fibers. Surrounding cool air is induced into the hot air stream to cool and solidify the fibers. The fibers are then randomly deposited onto a foraminous surface to form a web. The web has integrity but may be additionally bonded if desired.

Besides meltblown webs, however, it should be understood that other fibrous webs can be used in accordance with the present invention. For instance, in an alternative embodiment, elastic spunbond webs can also be formed. Spunbond webs are typically produced by heating a thermoplastic polymeric resin to at least its softening temperature, then extruding it through a spinnerette to form continuous fibers, which can be subsequently fed through a fiber draw unit. From the fiber draw unit the fibers are spread onto a foraminous surface where they are formed into a web and then bonded such as by chemical, thermal or ultrasonic means.

In one embodiment, the elastic member can be a necked stretched bonded laminate. As used herein, a necked stretched bonded laminate is defined as a laminate made from the combination of a necked bonded laminate and a stretch-bonded laminate. Examples of necked stretched bonded laminates are disclosed in U.S. Pat. Nos. 5,114,781 and 5,116,662, which are both incorporated herein by reference. Of particular advantage, a necked stretched bonded laminate is stretchable in a machine direction and a cross machine direction.

Besides including a non-elastic component or an elastic component, the glove of the present invention can further include a moisture barrier that is incorporated into or laminated to a base web of the present invention. The moisture barrier can be a liquid-impervious layer or a liquid absorbent layer.

Such a barrier can prevent, or at least minimize, leakage from outside the glove by establishing a barrier to the passage of liquid from the glove to the finger placed therein. For example, as shown in FIG. 3, a layer of material or film can be provided to form the moisture barrier, which can act as a barrier between the outer layer of a glove and hand. However, it should also be understood that the moisture barrier may be a liner for both side of the glove. Moreover, the moisture barrier can be applied asymetrically or unevenly to the glove such that one portion is not. It should be understood that the moisture barrier can be applied to the glove as a layer of the base web, or as an outer lining for the base web. Moreover, it should also be understood that the moisture barrier can be inherent within the base web structure such that it would not constitute a separate lining thereof. It should also be understood that more than one barrier can be used if a glove is a multiple layer glove.

The barrier layer can be a elastic film sheet that is extruded as a blown film. Blown films are well known in the art and will not be discussed herein in detail. Briefly, the production of a blown film involves use of a gas, such as air, to expand a bubble of molten extruded polymer after the molten polymer has been extruded from an annular die. Processes for producing blown films are taught in, for example, U.S. Pat. No. 3,354,506 to Raley, U.S. Pat. No. 3,650,649 to Schippers, and U.S. Pat. No. 3,801,429 to Schrenk et al., all incorporated herein by reference in their entireties. It should be noted that the blow up ratio (the ratio of the circumference of the blown up film to the circumference of the inner circle of the film die) can be controlled by the amount of polymer extruded and by the amount of gas used to expand the bubble. By controlling the blow up ratio to match the width of the collapsed film sheet to the width of the available fibrous nonwoven web to be laminated, overlaps of one material past the width extent of the other, and thus associated trim waste, can be sharply reduced or even virtually eliminated. In addition, or alternatively, the width of the collapsed film sheet may be matched to suit both the available fibrous nonwoven web and the desired width of elastic laminate material which is to be used in a final product configuration, thereby reducing the waste that often occurs when the elastic laminate itself must be trimmed to fit in the final product.

In general, the elastic film sheet in the final nonwoven-film laminate material may have a basis weight of from about 5 gsm or less to about 100 gsm or greater. More desirably, the elastic film sheet may have a basis weight from about 5 gsm to about 68 gsm, and still more desirably from about 5 gsm to about 34 gsm. Because elastic materials are often expensive to produce, the elastic film sheet is desirably of as low basis weight as is possible while still providing the desired properties of stretch and recovery to the elastic laminate material.

Many elastomeric polymers are known to be suitable for forming fibers, foams and films. Thermoplastic polymer compositions useful for forming the elastic blown film may desirably comprise any elastic polymer or polymers known to be suitable elastomeric fiber or film forming resins including, for example, elastic polyesters, elastic polyurethanes, elastic polyamides, elastic co-polymers of ethylene and at least one vinyl monomer, block copolymers, and elastic polyolefins. Examples of elastic block copolymers include those having the general formula A-B-A′ or A-B, where A and A′ are each a thermoplastic polymer endblock that contains a styrenic moiety such as a poly (vinyl arene) and where B is an elastomeric polymer midblock such as a conjugated diene or a lower alkene polymer such as for example polystyrene-poly(ethylene-butylene)-polystyrene block copolymers. Also included are polymers composed of an A-B-A-B tetrablock copolymer, as discussed in U.S. Pat. No. 5,332,613 to Taylor et al. An example of such a tetrablock copolymer is a styrene-poly(ethylene-propylene)-styrene-poly(ethylene-propylene) or SEPSEP block copolymer. These A-B-A′ and A-B-A-B copolymers are available in several different formulations from the Kraton Polymers of Houston, Tex. under the trade designation KRATON®. Other commercially available block copolymers include the SEPS or styrene-poly(ethylene-propylene)-styrene elastic copolymer available from Kuraray Company, Ltd. of Okayama, Japan, under the trade name SEPTON®.

Examples of elastic polyolefins include ultra-low density elastic polypropylenes and polyethylenes, such as those produced by “single-site” or “metallocene” catalysis methods. Such polymers are commercially available from the Dow Chemical Company of Midland, Mich. under the trade name ENGAGE®, and described in U.S. Pat. Nos. 5,278,272 and 5,272,236 to Lai et al. entitled “Elastic Substantially Linear Olefin Polymers”. Also useful are certain elastomeric polypropylenes such as are described, for example, in U.S. Pat. No. 5,539,056 to Yang et al. and U.S. Pat. No. 5,596,052 to Resconi et al., incorporated herein by reference in their entireties, and polyethylenes such as AFFINITY® EG 8200 from Dow Chemical of Midland, Mich. as well as EXACT® 4049, 4011 and 4041 from Exxon of Houston, Tex., as well as blends.

Film layers or sheets, including elastic film layers, generally act as a barrier to the passage of liquids, vapors and gases. However, it may be desirable for the elastic film sheet layer to be breathable, that is, allow the passage of water vapor and/or gases. An elastic film sheet layer which is also breathable may provide increased in-use comfort to a wearer by allowing passage of water vapor and assist in reducing excessive skin hydration, and help to provide a more cool feeling. Therefore, where a breathable elastic laminate material is desired the thermoplastic elastic material used may be a breathable monolithic or microporous barrier film which acts as a barrier to passage of aqueous liquids, yet allows the passage of water vapor and air or other gases. Monolithic breathable films can exhibit good breathability when they comprise polymers which inherently have good water vapor transmission or diffusion rates such as, for example, polyurethanes, polyether esters, polyether amides, EMA, EEA, EVA and the like. Examples of elastic breathable monolithic films are described in U.S. Pat. No. 6,245,401 to Ying et al., incorporated herein by reference in its entirety, and include those comprising polymers such as thermoplastic (ether or ester) polyurethane, polyether block amides, and polyether esters.

As stated, microporous elastic films may also be used where a breathable elastic laminate material is desired. Microporous breathable films contain a filler material, such as for example calcium carbonate particles, in an amount usually from about 30 percent to 70 percent by weight of the film. The filler-containing film (or “filled film”) is then stretched or oriented to open micro-voids around the filler particles in the film, which micro-voids allow for the passage of air and water vapor through the film. Breathable microporous elastic films containing fillers are described in, for example, U.S. Pat. Nos. 6,015,764 and 6,111,163 to McCormack and Haffner, U.S. Pat. No. 5,932,497 to Morman and Milicevic, and in U.S. Pat. No. 6,461,457 to Taylor and Martin, all incorporated herein by reference in their entireties. Other breathable films having bonding agents are disclosed in U.S. Pat. Nos. 5,855,999 and 5,695,868 to McCormack, both incorporated herein by reference in their entireties. In addition, multilayer breathable films as are disclosed in U.S. Pat. No. 5,997,981 to McCormack et al., incorporated herein by reference in its entirety, may be useful. Still other suitable breathable films and film compositions are disclosed in co-assigned U.S. patent application Ser. No. 10/646,978 to McCormack and Shawver, filed Aug. 22, 2003 and entitled “Microporous Breathable Elastic Films, Methods Of Making Same, And Limited Use Or Disposable Product Applications”, which is incorporated herein by reference in its entirety.

In yet another embodiment of the invention, a cellular elastic film may be used to provide breathability where a breathable elastic laminate material is desired. Breathable cellular elastic film may be produced by mixing the elastic polymer resin with a cell opening agent which decomposes or reacts to release a gas that forms cells in the elastic film. The cell opening agent can be an azodicarbonamide, fluorocarbons, low boiling point solvents such as for example methylene chloride, water, or other agents such as are known to those skilled in the art to be cell opening or blowing agents which will create a vapor at the temperature experienced in the film die extrusion process. Cellular elastic films are described in PCT App. No. PCT/US99/31045 (WO 00/39201 published Jul. 6, 2000) to Thomas et al., incorporated herein by reference in its entirety.

As another example, it may be desirable to provide breathability to the laminate in circumstances where barrier properties are not particularly important or not desired. In such circumstances, either the elastic film sheet itself or the entire elastic laminate may be apertured or perforated to provide a laminate capable of allowing the passage of vapors or gases. Such perforations or apertures may be performed by methods known in the art such as for example slit aperturing or pin aperturing with heated or ambient temperature pins.

In one embodiment of the present invention, the moisture barrier can be made from liquid-impermeable plastic films, such as polyethylene and polypropylene films. Generally, such plastic films are impermeable to gases and water vapor, as well as liquids.

While completely liquid-impermeable films can prevent the migration of liquid from outside the glove to the hand, the use of such liquid- and vapor-impermeable barriers can sometimes result in a relatively uncomfortable level of humidity being maintained in glove.

As such, in some embodiments, breathable, liquid-impermeable barriers-are desired. For instance some suitable breathable, liquid-impermeable barriers can include barriers such as disclosed in U.S. Pat. No. 4,828,556 to Braun et al., which is incorporated herein in its entirety by reference. The breathable barrier of Braun et al. is a multilayered, cloth-like barrier comprised of at least three layers. The first layer is a porous nonwoven web; the second layer, which is joined to one side of the first layer, comprises a continuous film of PVOH; and the third layer, which is joined to either the second layer or the other side of the first layer not joined with the second layer, comprises another porous nonwoven web. The second layer continuous film of PVOH is not microporous, meaning that it is substantially free of voids which connect the upper and lower surfaces of the film.

In other cases, various breathable films can be constructed with micropores to provide breathability. The micropores form what is often referred to as tortuous pathways through the film. Liquid contacting one side of the film does not have a direct passage through the film. Instead, a network of microporous channels in the film prevents water from passing, but allows water vapor to pass.

In some instances, the breathable, liquid-impermeable barriers are made from polymer films that contain any suitable substance, such as calcium carbonate. The films are made breathable by stretching the filled films to create the microporous passageways as the polymer breaks away from the calcium carbonate during stretching. In some embodiments, the breathable film layers can be used in thicknesses of from about 0.01 mils to about 5 mils, and in other embodiments, from about 0.01 mils to about 1.0 mils.

An example of a breathable, yet fluid penetration-resistant material is described in U.S. Pat. No. 5,591,510 to Junker et al. The fabric material described by Junker et al. comprises a breathable outer layer of paper stock and a layer of breathable, fluid-resistant nonwoven material. The fabric also includes a thermoplastic film having a plurality of perforations which allow the film to be breathable while resisting direct flow of liquid therethrough.

In addition to the films mentioned above, various other breathable films can be utilized in the present invention. One type of film that may be used is a nonporous, continuous film, which, because of its molecular structure, is capable of forming a vapor-permeable barrier. Among the various polymeric films which fall into this type include films made from a sufficient amount of poly(vinyl alcohol), polyvinyl acetate, ethylene vinyl alcohol, polyurethane, ethylene methyl acrylate, and ethylene methyl acrylic acid to make them breathable. Although the inventors do not intend to be held to a particular mechanism of operation, it is believed that films made from such polymers solubilize water molecules and allow transportation of those molecules from one surface of the film to the other.

Accordingly, such films may be sufficiently continuous, i.e., nonporous, to make them liquid-impermeable but still allow for vapor permeability.

Still, other breathable, liquid-impermeable barriers that can be used in the present invention are disclosed in U.S. patent application Ser. No. 08/928,787 entitled “Breathable, Liquid-impermeable, Apertured Film/Nonwoven Laminate and Process for Making the Same”, which is incorporated herein in its entirety by reference. For example, breathable films and/or apertured films can be utilized in the present invention. Such films can be made within a laminate structure. In one embodiment, a breathable, liquid-impermeable, apertured film/nonwoven laminate material can be formed from a nonwoven layer, a film layer with apertures, and a breathable film layer.

The layers may be arranged so that the apertured film layer or the breathable film layer is attached to the nonwoven layer. For instance, in one embodiment, an apertured film can be used in the present invention that is made from any thermoplastic film, including polyethylene, polypropylene, copolymers of polypropylene or polyethylene, or calcium carbonate-filled films. The particular aperturing techniques utilized to obtain the apertured film layer may be varied. The film may be formed as an apertured film or may be formed as a continuous, non-apertured film and then subjected to a mechanical aperturing process.

Moisture barrier laminates can be formed from many processes such as for example, meltblowing processes, spunbonding processes, coforming processes, spunbonding/meltblowing/spunbonding processes (SMS), spunbonding/meltblowing processes (SM), and bonded carded web processes. For instance, in one embodiment, the nonwoven layer of a laminate moisture barrier of the present invention is a spunbond/meltblown/spunbond (SMS) and/or spunbond/meltblown (SM) material. An SMS material is described in U.S. Pat. No. 4,041,203 to Brock et al. which is incorporated herein in its entirety by reference. Other SMS products and processes are described for example in U.S. Pat. No. 5,464,688 to Timmons et al., U.S. Pat. No. 5,169,706 to Collier et al. and U.S. Pat. No. 4,766,029 to Brock et al., all of which are also incorporated herein in their entireties by reference. Generally, an SMS material will consist of a meltblown web sandwiched between two exterior spunbond webs. Such SMS laminates are available from Kimberly-Clark Corporation under marks such as Spunguard™ and Evolution™. The spunbonded layers on the SMS laminates provide durability and the internal meltblown barrier layer provides porosity and additional clothlike feel. Similar to an SMS laminate, an SM laminate is a spunbond layer laminated to a meltblown layer.

In forming an glove of the present invention with a moisture barrier, the barrier can be bonded together with the other layers of the glove in a number of various ways. Thermal bonding, adhesive bonding, ultrasonic bonding, extrusion coating, and the like, are merely examples of various bonding techniques that may be utilized in the present process to attach the moisture barrier to the fibrous layers of the glove.

In another aspect of the invention, the elastomeric barrier film can includes a chemical protection layer that will not substantially dissolve when contacted with certain chemicals or solvents. For example, in one embodiment, a chemical protection layer contains at least one crosslinked, modified silicone elastomer. As used herein, the term “modified silicone” generally refers to a broad family of synthetic polymers that have a repeating silicon- oxygen backbone with organic groups attached to the backbone (pendant and/or terminating). For instance, some suitable silicones that can be used in the present invention include, but are not limited to, phenyl- modified silicones, vinyl-modified silicones, methyl-modified silicones, fluoro-modified silicones, alkyl-modified silicones, alkoxy-modified silicones, alkylamino-modified silicones, and combinations thereof. Some suitable phenyl-modified silicones include, but are not limited to, dimethyldiphenylpolysiloxane copolymers; dimethyl, methylphenylpolysiloxane copolymers; polymethylphenylsiloxane; and methylphenyl, dimethylsiloxane copolymers. Phenyl modified silicones that have a relatively low phenyl content (less than about 50 mole %) may be particularly effective in the present invention. For example, the phenyl-modified silicone can be a diphenyl-modified silicone, such as a diphenylsiloxane-modified dimethylpolysiloxane.

For most applications, the phenyl-modified silicones contain phenyl units in an amount from about 0.5 mole % to about 50 mole %, in some embodiments in an amount less than about 25 mole %, and in some embodiments, in an amount less than about 15 mole %. In one particular embodiment, a diphenylsiloxane-modified dimethylpolysiloxane can be used that contains diphenylsiloxane units in an amount less than about 5 mole %, and particularly in an amount less than about 2 mole %. The diphenylsiloxane-modified dimethylpolysiloxane can be synthesized by reacting diphenylsiloxane with dimethylsiloxane.

As indicated above, fluoro-modified silicones can also be used in the present invention. For instance, one suitable fluoro-modified silicone that can be used is a trifluoropropyl modified polysiloxane, such as a trifluoropropylsiloxane modified dimethylpolysiloxane. A trifluoropropylsiloxane modified dimethylpolysiloxane can be synthesized by reacting methyl, 3,3,3 trifluoropropylsiloxane with dimethylsiloxane. The fluoro-modified silicones can contain from about 5 mole % to about 95 mole %, and in some embodiments, from about 40 mole % to about 60 mole % of fluoro groups, such as trifluoropropylsiloxane units. In one embodiment, a trifluoropropylsiloxane-modified dimethylpolysiloxane is used that contains 50 mole % trifluoropropylsiloxane units.

Besides the above-mentioned modified silicone elastomers, other modified silicone elastomers may also be utilized in the present invention. For instance, some suitable vinyl-modified silicones include, but are not limited to, vinyldimethyl terminated polydimethylsiloxanes; vinylmethyl, dimethylpolysiloxane copolymers; vinyldimethyl terminated vinylmethyl, dimethylpolysiloxane copolymers; divinylmethyl terminated polydimethylsiloxanes; polydimethylsiloxane, mono vinyl, mono n-butyldimethyl terminated; and vinylphenylmethyl terminated polydimethylsiloxanes. Further, some methyl-modified silicones that can be used include, but are not limited to, dimethylhydro terminated polydimethylsiloxanes; methylhydro, dimethylpolysiloxane copolymers; methylhydro terminated methyloctyl siloxane copolymers; and methylhydro, phenylmethyl siloxane copolymers.

If desired, the chemical protection layer can be formed from two or more separate components. When utilized, the separate components may contain the same or different types of modified silicone elastomers. For example, in one embodiment, the chemical protection layer contains two components, designated herein as part “A” and “B”. In one embodiment, part A contains a polydimethylsiloxane that is vinyl and methyl terminated. A platinum catalyst is also included that contains a complex of platinum with vinyl-containing oligosiloxanes (complex of platinum and divinyltetramethyldisiloxane with typical levels of active platinum of 5 to 50 parts per million). Part B is essentially identical to part A, except that it also includes a crosslinker and crosslinking inhibitor. The crosslinker can be, for example, polydimethylsiloxane with hydrogen on the siloxane chain, commonly called methyl hydrogen. The crosslinker concentration can vary from about 0.3 to about 4 parts per hundred parts of the mass of polydimethylsiloxane. The crosslinking inhibitor can, for example, contain an oligosiloxane with high concentration of vinyl-containing substituents of any of the class of compounds known as acetylinic alcohols. For example, one suitable crosslinking inhibitor is tetravinyl tetramethyl cyclotetrasiloxane. The inhibitor may be used in concentrations as low as 0.02 parts per hundred parts to as high as 0.5 parts per hundred parts. In forming the outer layer 36, parts A and B are mixed together prior to dipping in a 1:1 ratio by weight.

Some commercially available diphenyl modified dimethylsilicones, such as described above, can be obtained from NuSil Technologies under various trade names including MED 6400, MED 10-6400, MED 6600, MED 10-6600, MED 6640, and MED10-6640.

Other suitable modified silicone elastomers that can be used in the present invention are believed to be described in U.S. Pat. No. 4,309,557 to Compton, et al.; U.S. Pat. No. 6,136,039 to Kristonsson, et al.; U.S. Pat. No. 6,160,151 to Compton, et al.; U.S. Pat. No. 6,243,938 to Lubrecht; and WO 01/41700, which are incorporated herein in their entirety by reference thereto for all purposes. Moreover, the modified silicone elastomers used in the present invention may also contain fillers, such as reinforcing silica; processing aids; additives; pigments; and the like, as is conventional in the art.

A chemical resistant agent can be applied to the barrier film to protect the polymer film from caustic chemicals. The solids content and/or viscosity of the chemical protection layer can generally be varied to achieve the desired chemical resistance. For example, the modified silicone elastomer(s) used to form the chemical protection layer can have a solids content of between about 5% to about 40%, and in some embodiments, between about 10% to about 35%. To lower the solids content of a commercially available modified silicone elastomer, for example, additional amounts of solvent can be utilized. Further, the viscosity of the modified silicone elastomer(s) used to form the chemical protection layer can range from about 300 centipoise to about 7000 centipoise, and in some embodiments, from about 600 to about 4000 centipoise. By varying the solids content and/or viscosity of the chemical protection layer, the presence of the modified silicone elastomer in the glove can be controlled. For example, to form a glove with a higher level of chemical resistance, the modified silicone elastomer used in such layer can have a relatively high solids content and viscosity so that a greater percentage of the silicone is incorporated into the layer during the forming process. The thickness of the chemical protection layer can also vary. For example, the thickness can range from about 0.001 millimeters to about 0.4 millimeters, in some embodiments, from about 0.01 millimeters to about 0.30 millimeters, and in some embodiments, from about 0.01 millimeters to about 0.20 millimeters.

In some embodiments, fiber layers of the current invention can also be treated with chemical protection reagents such as discussed above.

In some embodiments, any of the above layers and/or materials can also be dyed or colored so as to form a base web or moisture barrier having a particular color. For example, in one embodiment, the moisture barrier can be provided with a colored background. For instance, white tufts, colored tufts, and/or a white titanium oxide background could be utilized. In one embodiment, a dye can be placed in one of the layers as an indicator for leakage when the glove is broken. In this case, a dye that can give a color change upon contact with a solvent or aqueous biological fluids.

The polypropylene spunbond layers made from spunbond polypropylene filaments can have a basis weight of from about 0.3 osy to about 1.0 osy, and can particularly have a basis weight of about 0.5 osy. The moisture barrier layer, on the other hand, can be a film made from linear low-density polyethylene containing a calcium carbonate filler. The film can be stretched in order to create pores for making the film breathable while remaining substantially impermeable to liquids. The moisture barrier layer can have a basis weight from about 0.2 osy to about 1.0 osy, and particularly can have a basis weight of about 0.5 osy. The necked polypropylene spunbond layer can be adhesively secured to the moisture barrier layer.

The exterior layer can be a spunbond or through air bonded web made from bicomponent polyethylene/polypropylene filaments in a side-by-side arrangement. The exterior layer can have a basis weight of from about 1.0 osy to about 5.0 osy, and can particularly have a basis weight of from about 2.0 osy to about 4.0 osy. Alternatively, the exterior layer itself can be a layered or laminate structure. For example, a two-banked process can be used in which a layer of larger diameter fibers is formed on a layer of small diameter fibers.

The exterior bicomponent spunbond layer can be laminated to other layers using a thermal point bonding process, such as a point unbonded pattern process.

The glove of the present invention can be fully made from an elastic laminate. For instance, the glove can be a stretch-bonded laminate sheet. The stretch-bonded laminate sheet can include elastic threads made from an elastomeric material sandwiched between two polypropylene spunbond layers. The elastic threads can be, for instance, made from a styrene-ethylene butylene-styrene copolymer, such as KRATON G2740 available from the Krayton Polymer Company. The stretch-bonded laminate can have a basis weight of from about 1.0 osy to about 5 osy, particularly from about 1.5 osy to about 2.5 osy, and more particularly from about 2.0 osy to about 3.0 osy.

Instead of a stretch bonded laminate sheet, the glove can also be made from a neck bonded laminate sheet. The neck bonded laminate sheet can include a metallocene catalyzed elastic polyethylene film sandwiched between two polypropylene spunbond layers. The spunbond layers can have a basis weight of about 0.45 osy prior to being stretched. The polyethylene film, on the other hand, can have a basis weight from about 0.5 osy to about 1.5 osy.

The glove can be made with attaching two separate elastic laminates together using various methods such as ultrasonic bonding, sewing, and the like. In general, any suitable cutting method can be used in order to trim away excess material. For example, the material can be cut using a high pressure jet of water referred to as a water knife or can be cut using a conventional mechanical device, such as a cutter or a pair of shears. In one embodiment, the glove can be simultaneously bonded together and cut from the materials from which they are made. For instance, ultrasonic energy can be used to bond and cut materials in one step.

In an alternative variation of the protective article, one may apply a pre-stretched microporous polyolefin, such as a filled high-density polyethylene material, laminated to necked spunbond facings can create an elastic stretchable substrate. Such a laminate structure can permit one to adapt non-elastic film materials to create a elastic article. In the lamination, the necked spunbond, for example, permits expansive stretch, while the attached film layer provide both extension and retraction (i.e., compressive force) properties to the laminate.

The specific dimensions of the protective article that is formed in accordance with the present invention will depend upon the particular application and purpose for which the glove or foot wear is to be used. For instance, the glove can be constructed in order to fit around the hand of an adult or the hand of a child.

C. Therapeutic Application

In order to provide therapeutic benefits to a hand or foot, a variety of chemicals can be applied to the glove, or a part of the glove, of the present invention. When used as for wounds, cuts, bruises, blisters, dry skin, etc., for example, the whole glove or part of the glove of the present invention can generally include any additive commonly used as healing or pain-killing agents, particularly those which are currently used on conventional appendage bandages. Examples of such additives can include, but are not limited to, antibiotics, anti-microbial agents, anti-inflammatory agents, neosporin, moisturizing agents, cationic polymers, and the like.

For instance, cationic polymers can help clean wounds because they typically have a strong attraction for negatively charged bacteria and deleterious acidic byproducts. One example of a cationic polymer that is suitable for use in the present invention is chitosan (poly-N-acetylglucosamine, a derivative of chitin) or chitosan salts. Chitosan and its salts are natural biopolymers that can have both hemostatic and bacteriostatic properties. As a result, chitosan can help reduce bleeding and infection. In addition to chitosan and chitosan salts, any other cationic polymers, such as cationic starches (e.g. COBOND made by National Starch) or oligomeric compounds can be used. In some embodiments, combinations of cationic materials can be utilized. In addition, as mentioned above, when used as a glove for treating other ailments, such as arthritis; “black toe”, “trigger finger”; or jammed, sprained, hyper-extended, dislocated, or broken appendages, an appendage sleeve of the present invention can generally include any additive commonly used to treat such ailments. Examples of such additives can include, but are not limited to, topical analgesics (e.g. BEN-GAY), anti-inflammatory agents, vasodilators, corticosteroids, dimethyl sulfoxide (DMSO), capsaicin, menthol, methyl salicylate, DMSO/capsaicin, cationic polymers, anti-fungal agents, and the like. For instance, suitable anti-inflammatory agents can include any cyclooxygenase-1 (COX-1) or cyclooxygenase-2 (COX-2) inhibitors.

In general, the chemical additives described above can be applied to a glove of the present invention according to a number of ways known in the art. For example, the additives can be applied to the glove using a saturant system, such as disclosed in U.S. Pat. No. 5,486,381 to Cleveland et al., which is incorporated herein by reference. Moreover, the additives can also be applied by various other methods, such as print, blade, roll, spray, spray-drying, foam, brush treating applications, etc., which are well known in the art. The additives can further be applied as a mixture of molten solids or co-extruded onto the glove. Additionally, in another embodiment, the chemical additives can be impregnated into the material during manufacturing as is well known in the art. It should be understood that when coated onto a glove as described above, the additives can be applied to the base web before or after the base web is stamped or bonded to form an appendage sleeve of the present invention. Furthermore, if desired, it should also be understood that various additives, solutions, and chemicals can be applied by the consumer to the appendage sleeve just before use.

In another embodiment, the additive can be encapsulated and then applied to the glove or foot cover. Encapsulation is a process by which a material or mixture of materials is coated with or entrapped within another material or mixture of materials. The technique is commonly used in the food and pharmaceutical industries. The material that is coated or entrapped is normally a liquid, although it can also be a solid or gas, and is referred to herein as the core material. The material that forms the coating is referred to as the carrier material. A variety of encapsulation techniques are well-known in the art and can be used in the current invention, including spray drying, spray chilling and cooling, coacervation, fluidized bed coating, liposome entrapment, rotational suspension separation, and extrusion.

To prepare a material for spray drying, the carrier material is dissolved in an aqueous solution. The core ingredient is added to this solution and mixed thoroughly. A typical load of carrier to core material is 4:1, although much higher or lower loads can be used. The mixture is homogenized, and then fed into a spray dryer where it is atomized and released into a stream of hot air. The water is evaporated, leaving a dried particle comprising the core material trapped within the carrier matrix.

Suitable carrier materials include but are not limited to gums, gum Arabic, modified starches, gelatin, cellulose derivatives, and maltodextrins. Suitable core materials include but are not limited to flavors, natural oils, additives, sweeteners, stabilizers besides the other various additives mentioned above.

Regardless of the mechanism utilized to apply the chemical additives to the glove, the additives can be applied to the glove via an aqueous solution, non-aqueous solution, oil, lotion, cream, suspension, gel, etc. When utilized, an aqueous solution can contain any of a variety of liquids, such as various solvents and/or water. Moreover, the solution can often contain more than one additive. In some embodiments, the additives applied by an aqueous solution or otherwise constitute approximately less than 80% by weight of the glove. In other embodiments, in order to maintain sufficient absorbency of the glove, the additives can be applied in an amount less than about 50% of the weight of the glove.

Moreover, in some embodiments, the additives can also be applied asymmetrically onto the glove to reduce costs and maximize performance of the glove. For instance, the glove is stamped and bonded, and thereafter asymmetrically coated with a particular coating agent onto at a finger area. A glove, in accordance with the present invention, made with a stretchable, breathable non-woven material can be employed for a variety of uses, such as for work or medical examination gloves, as well as for cosmetic or therapeutic applications, depending on the glove's specific configuration or design. A foot covering, in accordance with the present invention, can include shoe or boot cover, slipper, or socks.

Although the present invention is described in terms of a glove or foot covering for purposes of illustration, the present invention is not necessarily so limited. Other kinds of articles may be formed from the materials described according to the present technique and construction. These other articles may include disposable protection garments for a variety of work environments, such as, clinical or medical examination, industrial or clean room operations, and/or where characteristics such as the added strength, comfort, skin protection, and powder-free aspects of the present invention are desirable. Medically or therapeutically oriented items such as face masks, head coverings (e.g., bouffant caps, surgical caps and hoods), coveralls, lab coats, aprons and jackets, gowns, drapes, wound dressings, bandages, sterilization wraps, cosmetic pads, patient bedding, stretcher and bassinet sheets, and the like.

### Section IV—Examples of Embodiments

Having described the general concept of the present invention, reference now will be made to the following examples of possible embodiments. Each example is provided by way of explanation of the invention, not limitation of the invention. Various gloves were made according to the present invention and tested. The gloves were made with various materials as described in the following examples. The gloves were constructed from the materials using ultrasonic welding to form with seams or seamless, depending upon the specific materials. In each of the following examples, unless otherwise specified, each glove was made using a mould having a length of from about 3 inches to about 14 inches.

### EXAMPLE 1

A protective article of the present invention in the form of a glove is formed as follows: A first section made from a point unbonded spunbond laminate material is ultrasonically welded to a stretch-bonded laminate (SBL) sheet using a Branson 920 IW ultrasonic welder. The point unbonded spunbond laminate forms the palm-side or front of the glove, while the SBL sheet forms the back of the glove. The point unbonded spunbond laminate was formed by thermally bonding together a polypropylene spunbond web, a breathable film sheet, and a bicomponent spunbond web. A breathable film sheet was placed in between the spunbond webs. The polypropylene spunbond web had a basis weight of 0.5 osy. The bicomponent spunbond web was made from bicomponent filaments having a polyethylene component and a polypropylene component in a side-by-side relationship. The bicomponent spunbond web had a basis weight of 2.5 osy. The breathable film sheet was made from a linear low density polyethylene containing a calcium carbonate filler. The film was stretched in order to create a microporous film. The film had a basis weight of 0.5 osy.

The bicomponent spunbond web was thermally bonded to the film laminate using a point-unbonded pattern that created texture. In particular, circular tufts were formed on the bicomponent spunbond web side of the laminate. During bonding, a top bond roll having the point-unbonded pattern was heated to 260° F. while a bottom bond roll was heated to 240° F.

The SBL sheet includes threads of an elastic material sandwiched between two polypropylene spunbond layers. The elastic material used was KRATON G2740 S-EB-S block copolymer available from the Krayton Polymer Inc. The SBL sheet had a basis weight of 2.5 osy. An imprinted, magnesium bond plate served as an anvil for ultrasonic bonding of the SBL sheet to the point unbonded spunbond laminate.

The bicomponent spunbond layer of the point unbonded spunbond material is placed adjacent to the SBL sheet during the ultrasonic welding process, which placed the textured nubs against the SBL sheet. After ultrasonic welding, excess material was trimmed around the edges and the glove was inverted to place the seam on the inside and the textured nubs on the outside.

### EXAMPLE 2

In this example, a glove as described in Example 1 is constructed, however, the bicomponent spunbond sheet of the point unbonded spunbond laminate had a basis weight of 3.6 osy. During the point unbonded process, the top bond roll was heated to 270° F., while the bottom bond roll was heated to 240° F.

### EXAMPLE 3

A glove is constructed similar to the glove described in Example 1. In this embodiment, however, the bicomponent spunbond sheet of the point unbonded spunbond laminate was a through air bonded bicomponent fibrous web having a basis weight of 1.8 osy. The bicomponent filaments contained a polyethylene component and a polypropylene component in a side-by-side relationship. During the point unbonded process, the top bond roll was heated to 260° F. while the bottom bond role was heated to 240° F. After the glove was formed, the glove was inverted so that the textured nubs as described in Example 1 were placed on the outside.

### EXAMPLE 4

A glove as described in Example 3 is constructed, however, the through air bonded bicomponent fibrous web had a basis weight of 2.5 osy.

### EXAMPLE 5

A glove as described in Example 1 was constructed, however, the point unbonded spunbond laminate was replaced with a multi-layered material that included a spunbond-meltblown-spunbond laminate. The spunbond-meltblown-spunbond laminate had a total basis weight of 1.0 osy. The laminate included a 0.4 osy meltblown interior layer made from polypropylene fibers. The two spunbond facings were also made from polypropylene.

The resulting multi-layered material was ultrasonically welded to the stretch-bonded laminate described in Example 1, such that the spunbond-meltblown-spunbond layer was positioned adjacent to the stretch-bonded layer.

### EXAMPLE 6

A glove as described in Example 1 was constructed and adapted for use to remove cosmetic make-up. In this example, the point unbonded spunbond laminate is replaced with a coform sheet. The coform sheet was a meltblown web containing 50% pulp fibers and 50% by weight polypropylene fibers. The coform sheet had a basis weight of 1.2 osy. The coform sheet was ultrasonically welded to the stretch-bonded laminate described in Example 1. In this example, the glove was not inverted. Further, the section of the glove made from the coform sheet was longer than the section made from the stretch-bonded laminate creating a pull-on tab.

### EXAMPLE 7

A glove was constructed similar to the glove described in Example 1. The bicomponent spunbond web contained in the point unbonded spunbond laminate had a basis weight of 3.5 osy. During the point unbonded process, the top bond roll was heated to 270° F., while the bottom bond roll was heated to 250° F. In contrast to Example 1, instead of using a stretch-bonded laminate sheet, the point unbonded spunbond laminate was ultrasonically welded to a neck-bonded laminate. The neck-bonded laminate was formed by adhesively bonding a 15 gsm polyurethane film between a pair of opposing polypropylene spunbond facings. The adhesive used to form the neck-bonded laminate was Findley H2525A adhesive obtained from Findley, Inc. The spunbond facings had a basis weight of 0.5 osy prior to being stretched or necked. The spunbond facings were necked to a width corresponding to 30% of their original width. After the point unbonded spunbond laminate was welded to the neck-bonded laminate, the glove is inverted so that the textured nubs formed an exterior face of the glove.

### EXAMPLE 8

A glove is constructed similar to the glove described in Example 1, using the same point unbonded spunbond laminate. In contrast to Example 1, however, instead of using a stretch-bonded laminate as the elastic material, a neck-bonded laminate was used. The point unbonded spunbond laminate was ultrasonically welded to the neck-bonded laminate.

The neck-bonded laminate contained a 35 gsm metallocene-catalyze polyethylene film laminated to a pair of opposing polypropylene spunbond facings. Alternatively, the laminate can be a blend of about 20-45 gsm of a metallocene-catalyzed polyolefin with KRAYTON-G polymers. The spunbond facings had a basis weight of 0.5 osy prior to being stretched or necked. The spunbond facings were necked to a width corresponding to 45% of the original width.

After the point unbonded spunbond laminate was welded to the neck-bonded laminate, again the glove is inverted so that the textured nubs formed an exterior face of the glove.

### EXAMPLE 9

A glove similar to the glove described in Example 1 was constructed. In this example, however, the neck-bonded laminate sheet was formed by adhesively bonding a 15 gsm polyether amide elastic film (PEBAX-2533 film obtained from Elf Atochem) to a pair of opposing bidirectionally extensible polypropylene spunbond facings. The polypropylene spunbond facings had a basis weight of 0.3 osy prior to being stretched or necked. When attached to the elastic film, the spunbond facings were necked to a width corresponding to 40% of their original width and then crimped an amount to produce a 50% reduction in length.

The neck-bonded laminate was ultrasonically welded to the point unbonded spunbond laminate. The resulting glove was inverted and treated with peppermint oil. It was observed that the neck-bonded laminate sheet had elastic properties in two dimensions.

### EXAMPLE 10

A glove similar to the one described in example 1 was constructed. In this example, the point unbonded laminate had a total basis weight of 2.75 osy. Further, instead of being welded to a stretch-bonded laminate, the point unbonded laminate was adhesively secured to an elastomeric, melt blown polyether ester (ARNITEL EM400 polyether ester obtained from DSM Engineering Plastics). The melt blown polyether ester web had a basis weight of about 2 osy.

### EXAMPLE 11

A glove similar to the one described in Example 1 was constructed. In this example, the point unbonded laminate had a total basis weight of 2.75 osy, and the point unbonded laminate was welded to a spunbond-meltblown-spunbond laminate that had been adhesively bonded to a thin strip of an elastic material commonly used as leg elastics in diapers. Specifically, the spunbond-meltblown-spunbond laminate had a total basis weight of 1.0 osy wherein the meltblown interior layer had a basis weight of 0.4 osy. The elastic strip was adhesively bonded to the spunbond-meltblown-spunbond laminate. The elastic strip included elastic threads sandwiched between two polypropylene spunbond facings.

The resulting glove made by welding the spunbond-meltblown-spunbond laminate to the point unbonded spunbond sheet was elastic because of the elastic strip attached spunbond-meltblown-spunbond laminate. The elastic strip was not uniformly elastic. The glove was made so that the elastic film rested between the first and second knuckles of the glove of an adult after insertion of the hand.

### EXAMPLE 12

An alternative embodiment of a glove made in accordance with the present invention was formed as follows. In this example, the glove included a first section made from a spunbond-meltblown-spunbond laminate welded to a second section made from a neck-bonded laminate. The spunbond-meltblown-spunbond laminate formed the front side of the glove, while the neck-bonded laminate formed the back side.

The spunbond-meltblown-spunbond laminate was made from polypropylene and had a total basis weight of 0.8 osy. The neck-bonded laminate on the other hand, was similar to the neck-bonded laminate described in Example 10, except that it had a heavier weight film and heavier weight facings. Further, the facings were necked to a width 40% of their original width. The laminate had an overall basis weight of 4.2 osy.

The two sides were thermally bonded together in the shape of a hand with fingers and excess material was trimmed from the edges of the wipe. The wipe was thereafter inverted to place the seams on the inside. The spunbond-meltblown-spunbond laminate section of the glove was longer than the neck-bonded laminate section, such that a pull-on-tab was provided for ease in placing the wipe on a finger. Specifically, the length of the spunbond-meltblown-spunbond laminate section was approximately 5 centimeters while the length of the neck-bonded laminate was approximately 4 centimeters. Upon flattening of the glove, the width at the bottom of the wipe was approximately 2.4 centimeters.

### EXAMPLE 13

An alternative embodiment of a glove made in accordance with the present invention was formed as follows. In this example, the glove included a first section made from a spunbond-meltblown-spunbond laminate welded to a second section made from a neck-bonded laminate. The spunbond-meltblown-spunbond laminate formed the front side of the glove, while the neck-bonded laminate formed the back side.

The spunbond-meltblown-spunbond laminate was made from polypropylene and had a total basis weight of 0.8 osy. The neck-bonded laminate on the other hand, was similar to the neck-bonded laminate described in Example 10, except that it had a heavier weight film and heavier weight facings to have an overall basis weight of 4.2 osy. Further, the facings were necked to a width 40% of their original width.

The two sections were thermally bonded together and excess material was trimmed from the edges of the wipe. The wipe was thereafter inverted to place the seams on the inside. The spunbond-meltblown-spunbond laminate section of the glove was longer than the neck-bonded laminate section, such that a pull-on-tab was provided for ease in placing the wipe. Specifically, the length of the spunbond-meltblown-spunbond laminate section was approximately 5 centimeters while the length of the neck-bonded laminate was approximately 4 centimeters. Upon flattening of the glove, the width at the bottom of the wipe was approximately 2.4 centimeters.

### EXAMPLE 14

A glove is constructed similar to the glove in Example 1, insofar as an elastic material was welded to a texturized surface with a finger-shaped design. In contrast to Example 1, however, instead of using a stretch bonded laminate as the elastic material, a neck-bonded laminate was used. The neck-bonded laminate contained a 1.0 osy metallocene-catalyzed polyethylene film laminated to a pair of opposing polypropylene spunbond facings. The spunbond facings had a basis weight of 0.5 osy prior to being stretched or necked. The spunbond facings were necked to a width corresponding to 42% of their original width.

In further contrast to Example 1, the texturized material was not a point unbonded nonwoven, but rather a knitted nylon material having looped bristles approximately 3 to 4 mm in length. This knitted material had a basis weight of approximately 2.5 osy. The bristles had a consistent directional component, allowing scrubbing in a direction with relatively high or low coefficient of friction, i.e., both with and against “the grain.” The looped bristles were fairly homogeneous in size and distribution, and generally extended between 3 mm and 4 mm from the surface. The bristle loops were comprised of multiple filaments. The knitted material was ultrasonically welded to the neck-bonded laminate.

### EXAMPLE 15

A glove is constructed similar to the glove in Example 1, insofar as an elastic material was welded to a texturized surface with a finger-shaped design. In contrast to Example 1, however, instead of using a stretched bonded laminate as the elastic material, a necked bonded laminate was used. The neck-bonded laminate contained a 1.0 osy metallocene-catalyzed polyethylene film laminated to a pair of opposing polypropylene spunbond facings. The spunbond facings had a basis weight of 0.5 osy prior to being stretched or necked. The spunbond facings were necked to a width corresponding to 42% of their original width.

In further contrast to Example 1, the texturized material was not a point unbonded nonwoven, but rather a knitted nylon material having looped bristles approximately 3 mm in length. This knitted material had a basis weight of approximately 2.5 osy, and was ultrasonically welded around the perimeter to a breathable film laminate (1.0 osy), thereby providing a nonwoven/knit laminate containing looped bristles and a moisture barrier. The bristled, nonwoven/knit laminate was ultrasonically welded to the neck-bonded laminate such that the looped bristles were adjacent to the NBL. The glove was inverted, placing the seam on the inside and the bristles on the outside. The bristles may form part of an abrasive brush for cleaning purposes.

### EXAMPLE 16

A glove is constructed similar to the glove in Example 1. The point unbonded spunbond laminate was ultrasonically welded to a neck-bonded laminate. The neck-bonded laminate contained a 1.0 osy metallocene-catalyzed polyethylene film laminated to a pair of opposing polypropylene spunbond facings. The spunbond facings had a basis weight of 0.5 osy prior to being stretched or necked. The spunbond facings were necked to a width corresponding to 42% of their original width.

In further contrast to Example 1, the texturized material was a conventional loop fastener, VELCRO Med-Flex Tape 9399, comprised of nylon and Spandex. This material was elastic. The looped bristles were monofilament, and generally extended from 0.5 mm to 3 mm from the surface when unstretched, with some extending to 10 mm when tension was applied. The knitted material was ultrasonically welded to the neck-bonded laminate.

### EXAMPLE 17

A glove is constructed similar to the glove in Example 1. In contrast to Example 1, however, instead of using a stretch bonded laminate as the elastic material, a neck-bonded laminate was used. The neck-bonded laminate contained a 1.0 osy metallocene-catalyzed polyethylene film laminated to a pair of opposing polypropylene spunbond facings. The spunbond facings had a basis weight of 0.5 osy prior to being stretched or necked. The spunbond facings were necked to a width corresponding to 42% of their original width.

In further contrast to Example 1, the texturized material was a laminate comprised of a commercially available loop fastener, VELCRO Loop 002 Tape 0599, approximately 2.5 osy, comprised of nylon adhesively laminated to a breathable film laminate (1.0 osy). The texturized material, was ultrasonically welded to the necked bonded laminate.

### EXAMPLE 18

A glove is constructed similar to the glove in Example 1. In contrast to Example 1, however, instead of using a stretch bonded laminate as the elastic material, a neck-bonded laminate was used. The neck-bonded laminate contained a 1.0 osy metallocene-catalyzed polyethylene film laminated to a pair of opposing polypropylene spunbond facings. The spunbond facings had a basis weight of 0.5 osy prior to being stretched or necked. The spunbond facings were necked to a width corresponding to 42% of their original width. In further contrast to Example 1, the texturized material was a needlepunched nonwoven substrate, with a basis weight of approximately 0.5-5 osy. The texturized material was ultrasonically welded to the necked-bonded laminate.

### EXAMPLE 19

A therapeutic glove containing anti-ulcer components can be prepared with metronidazole and peppermint oil (20 microliters). Metronidazole was obtained in the form of a topical gel called METROGEL, which is commercially available from Galderma. A suspension of bismuth subsalicylate (200 microliters of PEPTO-BISMOL), metronidazole (50 mg of METROGEL lotion), tetracycline (10 mg of SUMYCIN), and peppermint oil (20 microliters) can be applied to an exterior nonwoven layer of an at least tri-layer laminate glove body.

A glove of the present invention was formed as follows. Specifically, a first section made from a point unbonded spunbond laminate material was ultrasonically welded to a stretch-bonded laminate (SBL) sheet using a Branson 920 IW ultrasonic welder. The point unbonded spunbond laminate formed the front of the glove, while the SBL sheet formed the back of the glove. The point unbonded spunbond laminate was formed by thermally bonding together a first polypropylene spunbond web, a breathable film sheet, and a second polypropylene spunbond web. The breathable film sheet was placed in between the spunbond webs.

The first polypropylene spunbond web had a basis weight of 0.5 osy. The second polypropylene spunbond web had a basis weight of 2.8 osy with an average fiber diameter of 7.05 denier. The breathable film sheet was made from a linear low density polyethylene containing a calcium carbonate filler. The film was stretched in order to create a microporous film. The film had a basis weight of 0.5 osy.

The point unbonded spunbond laminate material was thermally bonded using a point-unbonded pattern that created texture. In particular, circular tufts were formed on the second polypropylene spunbond web side of the laminate. During bonding, a top bond roll having the point-unbonded pattern was heated to 350° F. while a bottom bond roll was heated to 300° F.

The SBL sheet, on the other hand, included threads of an elastic material sandwiched between two polypropylene spunbond layers. The elastic material used was KRATON G2740 S-EB-S block copolymer available from the Krayton Polymer Inc. The SBL sheet had a basis weight of 2.5 osy. An imprinted, magnesium bond plate was used to bond the SBL sheet to the point unbonded spunbond laminate.

The second polypropylene spunbond layer of the point unbonded spunbond material was placed adjacent to the SBL sheet during the ultrasonic welding process, which placed the textured nubs against the SBL sheet. After ultrasonic welding, excess material was trimmed around the edges and the finger glove was inverted to place the seam on the inside and the textured nubs on the outside.

The resulting bonded wipe have a rounded region at the top and straight sides tapering outwards, such that the width of the bond pattern 1 cm from the top was 2.3 cm, and the width at 4.5 cm from the top was 2.8 cm.

Thereafter, tetracycline hydrochloride and peppermint oil (20 microliters) were added to the finger glove. The tetracycline hydrochloride was obtained from Apothecon, a subsidiary of Bristol-Myers Squibb, in the form of a drug sold as SUMYCIN. The tetracycline hydrochloride was applied to the finger glove in the form of a solution containing 100 microliters of a 40 mg SUMYCIN/milliliter solution in water.

### EXAMPLE 20

A point unbonded spunbond laminate material is formed by thermally fusing (using a point-unbonded pattern) three materials: a bicomponent spunbond web (PE/PP, side-by-side, 0.45 osy), a film (0.0007″ CATALLOY film, supplied by Pliant Corporation), and a through-air bonded web (PE/PP, side-by-side, 3.5 osy), with bond pressure, line speed, and temperature adequate to sustain the desirable level of bonding and texture. In this case, the top patterned roll was heated to 256° F., while the bottom bond roll was heated to 248° F. The resulting point unbonded spunbond laminate sheet was ultrasonically welded to a neck-bonded laminate (NBL) sheet using a Branson 920 IW ultrasonic welder. The neck-bonded laminate contained a 1.0 osy metallocene-catalyzed polyethylene film laminated to a pair of opposing polypropylene spunbond facings. The spunbond facings had a basis weight of 0.5 osy prior to being stretched or necked. The spunbond facings were necked to a width corresponding to 42% of their original width.

An imprinted, stainless steel bond plate served as the ultrasonic anvil to make the bond pattern. The bicomponent spunbond layer of the point unbonded laminate spunbond material was adjacent to the NBL during the ultrasonic welding process (meaning the textured nubs faced and were pressed against the SBL sheet during welding). After ultrasonic welding, excess material was trimmed around the edges, and the finger glove was inverted to place the seam on the inside and the textured nubs on the outside.

### EXAMPLE 21

A point unbonded spunbond laminate material was formed by thermally fusing (using a point-unbonded pattern) three materials: a bicomponent spunbond web (PE/PP, side-by-side, 0.45 osy), a film (0.0007″ CATALLOY film, supplied by Pliant Corporation), and a through-air bonded web (PE/PP, side-by-side, 3.5 osy), with bond pressure, line speed, and temperature adequate to sustain the desirable level of bonding and texture. In this case, the top patterned roll was heated to 256° F., while the bottom bond roll was heated to 248° F. The resulting point unbonded spunbond laminate sheet was ultrasonically welded to a neck-bonded laminate (NBL) sheet using a Branson 920 IW ultrasonic welder. The neck-bonded laminate contained a 1.0 osy metllocene-catalyzed polyethylene film laminated to a pair of opposing polypropylene spunbond facings. The spunbond facings had a basis weight of 0.5 osy prior to being stretched or necked. The spunbond facings were necked to a width corresponding to 42% of their original width.

An imprinted, stainless steel bond plate served as the ultrasonic anvil to make the finger-shaped bond pattern. The bicomponent spunbond layer of the point unbonded laminate spunbond material was adjacent to the NBL during the ultrasonic welding process (meaning the textured nubs faced and were pressed against the SBL sheet during welding). After ultrasonic welding, excess material was trimmed around the edges, and the finger toothbrush was inverted to place the seam on the inside and the textured nubs on the outside.

### EXAMPLE 22

A point unbonded spunbond laminate material was formed by ultrasonically fusing (using a point-unbonded pattern on a 2″ rotary ultrasonic anvil) two materials: a film (0.0007″ CATALLOY film, supplied by Pliant Corporation), and through-air bonded web (PE/PP, side-by-side, 3.8 osy), with bond pressure, power, and line speed adequate to sustain the desirable level of bonding and texture. The through-air bonded web was next to the patterned anvil during the bonding process. The resulting point unbonded spunbond laminate sheet was ultrasonically welded to a neck-bonded laminate (NBL) sheet using a Branson 290

IW ultrasonic welder. The neck-bonded laminate contained a 1.0 osy metallocene-catalyzed polyethylene film laminated to a pair of opposing polypropylene spunbond facings. The spunbond facings had a basis weight of 0.5 osy prior to being stretched or necked. The spunbond facings were necked to a width corresponding to 42% of their original width.

An imprinted, stainless steel bond plate served as the ultrasonic anvil to make the finger-shaped bond pattern. The bicomponent spunbond layer of the point unbonded laminate spunbond material was adjacent to the NBL during the ultrasonic welding process (meaning the textured nubs faced and were pressed against the SBL sheet during welding). After ultrasonic welding, excess material was trimmed around the edges, and the finger glove was inverted to place the seam on the inside and the textured nubs on the outside. Peppermint oil was added to the finger glove, which was subsequently used to clean the mouth of an adult.

### EXAMPLE 23

A point unbonded spunbond laminate material was formed by ultrasonically fusing (using a point-unbonded pattern on a 2″ rotary ultrasonic anvil) two materials: a breathable film sheet (LLDPE/CaCO 3)/polypropylene, 1.0 osy) and a through-air bonded web (PE/PP, side-by-side fibers 3.5 osy), with bond pressure, line speed, and temperature adequate to sustain the desirable level of bonding and texture. The resulting point unbonded spunbond laminate sheet was ultrasonically welded to a neck-bonded laminate (NBL) sheet using a Branson 920 IW ultrasonic welder. The neck-bonded laminate contained a 1.0 osy metallocene-catalyzed polyethylene film laminated to a pair of opposing polypropylene spunbond facings. The spunbond facings had a basis weight of 0.5 osy prior to being stretched or necked. The spunbond facings were necked to a width corresponding to 42% of their original width.

An imprinted, stainless steel bond plate served as the ultrasonic anvil to make the finger-shaped bond pattern. The bicomponent spunbond layer of the point unbonded laminate spunbond material was adjacent to the NBL during the ultrasonic welding process (meaning the textured nubs faced and were pressed against the SBL sheet during welding). After ultrasonic welding, excess material was trimmed around the edges, and the finger glove was inverted to place the seam on the inside and the textured nubs on the outside.

### EXAMPLE 24

A point unbonded spunbond laminate material was formed by ultrasonically fusing (using a point-unbonded pattern on a 2″ rotary ultrasonic anvil) two through-air bonded webs. Both webs were comprised of bicomponent, PE/PP, side-by-side fibers. The top web, adjacent to the patterned anvil during bonding, was comprised of pentalobal shaped fibers, and had a basis weight of 3.5 osy. The bottom web was comprised of conventional round fibers, and had a basis weight of 3.8 osy. Bond pressure (60 psi) and line speed (80 fpm) were set to ensure adequate bonding, although adjustments to the power could allow for other settings providing nearly equivalent bonding. The resulting point unbonded spunbond laminate sheet was ultrasonically welded to a neck-bonded laminate (NIBL) sheet using a Branson 920 IW ultrasonic welder. The neck- bonded laminate contained a 1.0 osy metallocene-catalyzed polyethylene film laminated to a pair of opposing polypropylene spunbond facings. The spunbond facings had a basis weight of 0.5 osy prior to being stretched or necked. The spunbond facings were necked to a width corresponding to 42% of their original width. An imprinted, magnesium bond plate served as the ultrasonic anvil to make the finger-shaped bond pattern. The bicomponent spunbond layer of the point unbonded laminate spunbond material was adjacent to the NBL during the ultrasonic welding process (meaning the textured nubs faced and were pressed against the SBL sheet during welding). After ultrasonic welding, excess material was trimmed around the edges, and the finger glove was inverted to place the seam on the inside and the textured nubs on the outside.

### EXAMPLE 25

A point unbonded spunbond laminate material was formed by ultrasonically bonding two through-air bonded webs. Both webs were comprised of bicomponent, PE/PP, side-by-side fibers. The depth of the round circles (corresponding the unbonded regions) in the patterned anvil was 0.060″. The top web, adjacent to the patterned anvil during bonding, was comprised of pentalobal shaped fibers, and had a basis weight of 3.5 osy. The bottom web was comprised of conventional round fibers, and had a weight of 3.8 osy. Bond pressure (60 psi) and line speed (80 fpm) were set to ensure adequate bonding, although adjustments to the power could allow for other settings providing nearly equivalent bonding. The resulting point unbonded spunbond laminate sheet was ultrasonically welded to a neck-bonded laminate (NBL) sheet using a Branson 920 IW ultrasonic welder. The neck-bonded laminate contained a 1.0 osy metallocene-catalyzed polyethylene film laminated to a pair of opposing polypropylene spunbond facings. The spunbond facings had a basis weight of 0.5 osy prior to being stretched or necked. The spunbond facings were necked to a width corresponding to 42% of their original width. An imprinted, magnesium bond plate served as the ultrasonic anvil to make the finger-shaped bond pattern. The bicomponent spunbond layer of the point unbonded laminate spunbond material was adjacent to the NBL during the ultrasonic welding process (meaning the textured nubs faced and were pressed against the SBL sheet during welding). After ultrasonic welding, excess material was trimmed around the edges, and the finger glove was inverted to place the seam on the inside and the textured nubs on the outside.

### EXAMPLE 26

A point unbonded spunbond laminate material was formed by ultrasonically bonding two through-air bonded webs. Both webs were comprised of bicomponent, PE/PP, side-by-side fibers. The depth of the round circles (corresponding the unbonded regions) in the patterned anvil was 0.120″. The top web, adjacent to the patterned anvil during bonding, was comprised of pentalobal shaped fibers, and had a basis weight of 3.5 osy. The bottom web was comprised of conventional round fibers, and had a basis weight of 3.8 osy. Bond pressure (60 psi) and line speed (80 fpm) were set to ensure adequate bonding, although adjustments to the power could allow for other settings providing nearly equivalent bonding. The resulting point unbonded spunbond laminate sheet was ultrasonically welded to a neck-bonded laminate (NBL) sheet using a Branson 920 IW ultrasonic welder. The neck-bonded laminate contained a 1.0 osy metallocene-catalyzed polyethylene film laminated to a pair of opposing polypropylene spunbond facings. The spunbond facings had a weight of 0.5 osy prior to being stretched or necked. The spunbond facings were necked to a width corresponding to 42% of their original width.

An imprinted, magnesium bond plate served as the ultrasonic anvil to make the finger-shaped bond pattern. The bicomponent spunbond layer of the point unbonded laminate spunbond material was adjacent to the NBL during the ultrasonic welding process (meaning the textured nubs faced and were pressed against the SBL sheet during welding). After ultrasonic welding, excess material was trimmed around the edges, and the finger glove was inverted to place the seam on the inside and the textured nubs on the outside.

### EXAMPLE 27

A glove as described in Example 1 was constructed and used to apply petroleum jelly to an infant during a diaper change. In this example, however, the point unbonded spunbond laminate was replaced with a spunbond/meltblown/spunbond laminate. The laminate had a basis weight of 1.4 osy and was made entirely from polypropylene fibers. The laminate was ultrasonically welded to the stretch-bonded laminate described in Example 1. In this example, the glove was inverted. The glove was then subsequently dipped in petroleum jelly, which was applied to an infant during a diaper change.

The present invention has been described in general and in detail by way of examples. Aspects of the various embodiments may be interchanged either in whole or in part, and specific terms, devices, and methods described are for illustrative purposes only. The words used are words of description rather than of limitation. Persons of ordinary skill in the art understand that the invention is not limited necessarily to the embodiments specifically disclosed, but that modifications and variations may be made without departing from the scope of the invention as defined by the following claims or their equivalents, including other equivalent components presently known, or to be developed, which may be used within the scope of the present invention. Therefore, unless changes otherwise depart from the scope of the invention, the changes should be construed as being included herein and the appended claims should not be limited to the description of the preferred versions herein.

We claim:

1. A breathable protective article comprising: a laminate construction of at least a first barrier layer and at least a first nonwoven fiber web, said barrier layer is liquid impermeable, but vapor permeable and is reinforced on at least one side with at least said nonwoven fiber web, and both said barrier layer and nonwoven fiber web at least in part exhibit multidirectional elasticity.

2. The protective article according to claim 1, wherein said article is adapted to flex and conform snuggly to a three-dimensional portion of a wear's body without either binding or restricting movement.

3. The protective article according to claim 1, nonwoven fiber layer includes substantially continuous fibers.

4. The protective article according to claim 1, wherein said barrier layer is a polymer film that is either monolithic or microporous.

5. The protective article according to claim 1, wherein said barrier layer is made from a material selected from either polar or nonpolar elastomeric polymers.

6. The protective article according to claim 1, wherein said article further includes multiple laminations of said barrier and non-woven fiber layers.

7. The protective article according to claim 1, wherein in said multiple laminations said barrier and nonwoven fiber layers alternate.

8. The protective article according to claim 1, wherein said article further has an overcoat composed of a natural or synthetic polymer-based elastomer, applied over at least a portion of said laminate construction.

9. The protective article according to claim 8, wherein said overcoat is made from a material selected from natural latex rubber, nitrile, vinyl, or styrene-ethylene-butylene-styrene (S-EB-S), or styrene-butadiene-styrene (SBS) polymer materials.

10. The protective article according to claim 1, wherein said nonwoven fiber layer serves as a separator layer and is adapted to wick moisture.

11. The protective article according to claim 1, wherein said nonwoven fiber layer is a hydrophobic material.

12. The protective article according to claim 1, wherein said hydrophobic material is treated with a surfactant.

13. The protective article according to claim 1, wherein said nonwoven fiber web is an elastomeric nonwoven web.

14. The protective article according to claim 1, wherein said nonwoven fiber web includes stretchable bonded laminates, neck bonded laminates, spunbonded webs, meltblown webs, spunbonded/meltblown/spunbonded webs, spunbonded/meltblown webs, air bonded webs, or bonded carded webs.

15. The protective article according to claim 1, wherein at least about 75% of individual fibers in said nonwoven fiber layer has a length of over about 1 mm.

16. The protective article according to claim 1, wherein said laminate construction includes a moisture barrier layer positioned in between a first nonwoven web and a second nonwoven web.

17. The protective article according to claim 1, wherein said article is a species in one of the following groups: 1) glove, foot wear, face masks, or head coverings; 2) gowns, drapes, coveralls, lab coats, aprons and jackets; 3) cosmetic pads, patient bedding, stretcher and bassinet sheets; or 4) wound dressings, bandages, and sterilization wraps.

18. A protective non-absorbent article comprising: a laminated construction of at least a separator layer and a breathable barrier layer, said separator layer being composed of a multi-directional elastic and stretchable nonwoven fabric adapted to wick moisture away from human skin, and said breathable barrier layer is a polymer film, and said laminate construction is adapted to conform snuggly to a portion of a wearer's body.

19. The protective article according to claim 18, wherein the said polymer film is a moisture barrier layer.

20. The protective article according to claim 18, wherein said polymer film is coated with a chemical resistant agent.

21. The protective article according to claim 18, wherein said article further includes either a second nonwoven web or a second barrier layer, or both attached to said breathable barrier layer.

22. The protective article according to claim 21, wherein said second nonwoven layer or said second barrier layer has a texturized surface.

23. The protective article according to claim 22, wherein when said texturized surface is a nonwoven layer, said surface further includes either looped bristles, or a point unbonded material, said point unbonded material having a plurality of raised tufts surrounded by bonded regions.

24. The protective article according to claim 20, wherein said second nonwoven layer is reinforced by an elastomeric polymer coating that is continuous over at least a portion of said article.

25. The protective article according to claim 20, wherein said second nonwoven layer is reinforced by an elastomeric polymer coating that is either 1) a patterned and continuous, 2) patterned and discontinuous, or 3) random and discontinuous.

26. The protective article according to claim 20, wherein said second nonwoven fiber layers contains a colored pigment or a color changing dye as a leakage indicator.

27. The protective article according to claim 20, wherein said article is a glove.

28. The protective article according to claim 20, wherein said article is has at least two open ends.

29. The protective article according to claim 25, wherein a chemical protection formulation is applied over said elastomeric polymer coating.

30. A protective article for a hand or foot, said article comprising a first panel attached to a second panel forming a hollow enclosure adapted to receive a hand or foot, said first panel comprising at least a breathable, elastomeric, polymer, barrier layer laminated to an multidirectional elastic nonwoven fiber web, such that said barrier layer covers at least a portion of said nonwoven fiber web, said second panel comprising an elastic nonwoven fiber layer, and said first panel being attached to said second panel in a manner that can form a seam.

31. The protective article according to claim 30, wherein said elastic nonwoven fiber web is a material selected from stretchable bonded laminates, neck bonded laminates, spunbonded webs, meltblown webs, spunbonded/meltblown/spunbonded webs, spunbonded/meltblown webs, air bonded webs, or bonded carded webs.

32. The protective article according to claim 30, wherein said nonwoven fiber webs of said first and second panels include substantially continuous fibers.

33. The protective article according to claim 30, wherein at least about 75% of individual fibers in said first and second nonwoven fiber webs have a length over about 1 mm.

34. The protective article according to claim 30, wherein said article is a disposable article.

35. The protective article according to claim 30, wherein said article further includes an overcoat made from a material selected from natural latex rubber, nitrile, vinyl, or styrene-ethylene-butylene-styrene (S-EB-S), or styrene-butadiene-styrene (SBS) polymer materials, applied over at least a portion of said laminate construction.

36. The protective article according to claim 30, wherein said first panel is connected to said second panel in a manner that forms a seam with seam width of about 1 mm to about 5 mm, and said seam being turned toward inner part of said article.

37. The protective article according to claim 30, wherein said first panel is connected to said second panel in a manner that forms a flush seam with seam width of less than 1 mm.

38. A method of making a protective article for either hand or foot, said method comprises: providing a base material having at least a first nonwoven fiber web and a first breathable barrier layer; applying said base material to a mould or die, such that said non-woven fiber web is configured to become an inner lining for said article; and forming a hollow body article and sealing any seams.

39. The method according to claim 38, further comprising dipping said mould with said nonwoven-web-and-barrier-layer laminate body thereon into a bath of polymeric, elastomeric material to form an impermeable elastomeric coating over at least a portion of said article.

40. The method according to claim 38, further comprising either silk-screening or spraying said hollow body article with an polymeric elastomeric material to form a coating over at least a portion of said article.

41. The method according to claim 40, wherein said polymeric, elastomeric material includes nature rubber or synthetic latex, nitrile, vinyl, or styrene-ethylene-butylene-styrene (S-EB-S), or styrene-butadiene-styrene (SBS) polymer materials.

42. A non-absorbent protective article comprising an elastic stretchable substrate formed from a pre-stretched microporous polyolefin film laminated to a necked nonwoven facing, wherein in said lamination, said necked nonwoven facing allows for expansive stretching and said film provides both extension and retraction properties.
